(19) United States
(12) Patent Application Publication
(10) Pub. No.: US 2003/0200216 A1
(43) Pub. Date: Oct. 23, 2003

(54) Method and system for identification of music industry releases and licenses

(75) Inventors: Michael Anthony Hayes, Oxted (GB); Keith Ryan Hill, London (GB)

Correspondence Address: HALE & DORR LLP, THE WILLARD OFFICE BUILDING, 1455 PENNSYLVANIA AVE, NW, WASHINGTON, DC, 20004, US

(73) Assignee: Recording Industry Association of America, Washington, DC

(21) Appl. No.: 10/345,411

(22) Filed: Jan. 16, 2003

Related U.S. Application Data
(60) Provisional application No. 60/349,416, filed on Jan. 22, 2002.

(51) Int. Cl. G06F 7/00

(52) U.S. Cl. 707/9; 707/1

(57) ABSTRACT

A memory stores a data structure that comprises release identifier information relating to identification, validation, authorization, and/or use of data associated with releases and intellectual property rights associated with the releases. The data structure further includes a first data element that includes an issuer code, a second data element that includes an intellectual property bundle number, and a third data element that includes a check character. Another memory, or alternatively the same memory, stores a data structure that includes license identifier information relating to identification, validation, authorization, and/or use of data associated with licenses and intellectual property rights associated with the data. The data structure further includes a first data element that includes an issuer code, a second data element that includes a license reference, and a third data element that includes a check character.

### CROSS REFERENCE TO RELATED APPLICATIONS

This application claims priority from U.S. Provisional Application Serial No. 60/349,416, filed Jan. 22, 2002 and incorporated herein by reference.

### FIELD OF THE INVENTION

The present invention relates generally to managing releases and/or licenses for data and/or copyrighted data, and in particular, to the assignment and management of unique identifiers for identifying specific releases and/or licenses and the descriptive information associated with the specific releases and/or licenses for data and/or copyrighted data, for example, in the music industry.

### BACKGROUND OF THE RELATED ART

The exercise of rights associated with a musical work is the fundamental unit of transaction for music rights societies (“societies”). Consequently, the identification of musical works is at the core of the societies' business processes. Societies require their members to notify them of the musical works they own or administer. Societies also require other societies to notify them of works within different national repertoires, and societies require their licensees to provide information detailing the musical works that have been used under the various licenses operated by the societies.

The societies and their business partners have invested considerable resources in carrying out the activity of musical work identification and/or description, leading to the development of proprietary standards for the identification and descriptive information associated with musical works. However, as trade has become more global, these proprietary standards have become less effective, particularly with regard to licensees due to the complications of data transfer in multiple languages and/or using a multiplicity of different message formats.

The advent of the Internet and other global on-line environments for music exploitation adds an additional layer of complication: The speed in which information is exchanged and answers on questions expected to be returned from business partners makes correct and readily accessible information sources more important than ever. Within the music industry, for example, this leads to the requirement of precisely identifying, describing and tracking releases and licenses associated with those releases.

Exchange of such information between business partners may occur insecurely in cleartext or, where for example business reasons exist, as ciphered messages allowing for secure exchange of information related to releases and licenses.

U.S. Pat. No. 6,263,341 is incorporated herein by reference. The '341 patent discloses a method for modeling data in an information repository comprising the steps of identifying and defining a plurality of data objects containing data of interest and formulating relationships between the data objects.

FIG. 1 illustrates an application of an information repository to enterprise data modeling, which is the process of identifying unique enterprise data requirements and assuring that these data definitions are modeled only once by the stewarding application. The OBJECTS include ATTRIBUTES 900, which are technical definitions of data modeled in some computer application. ATTRIBUTES 900 are elementary data definitions such as product name, customer number, employee number, and other data which are of interest to the enterprise. Another OBJECT 12 is ENTITY 901, which is a logical collection of ATTRIBUTES 900. ENTITY 901 CONTAINS 902 ATTRIBUTE 900. CONTAINS relationship 902 documents the one-to-many relationship that each ENTITY 901 has with the attributes it contains. This relationship along with the ATTRIBUTE name, serves to uniquely identify each ATTRIBUTE. The organization of ATTRIBUTES 900 into a given ENTITY 901 is generally based on business rules, performance considerations, data access requirements, or a combination of these. ENTITY 901 represents collections of data that perform a specific task, such as define employee, define customer, or establish a linkage between other ENTITIES 901.

Each ENTITY 901 is defined to have at least one IDENTIFIER (not shown). Each IDENTIFIER is an ordered collection of ATTRIBUTES 900 uniquely identifying an ENTITY 901. Preferably, the IDENTIFIERS are implemented as indexes or keys on the particular ENTITY 901. VIEWS (not shown) are collections of ATTRIBUTES 900 returned when an ENTITY 901 is accessed by a particular IDENTIFIER. VIEWS may return every ATTRIBUTE 900 in the ENTITY 901, including IDENTIFIERS, or it may be artificially constricted by software acting on the database.

U.S. Pat. No. 5,765,152 is incorporated herein by reference. The '152 patent discloses a system and method for the secure electronic copyright management and automatic identification of ownership of creative works distributed as digital or electronic media, particularly over computer networks. One aspect of the invention provides a system which packages electronic media into a secure document format (“DOCUMENT”), including a data container for the media and a minimum permissions data set to specify the minimum authorizations needed to view or otherwise access the media.

The DOCUMENT can also include a document header, a document identifier, a source works extensions module which maintains a bibliographical history of the media, and a digital signature to authenticate the media. The DOCUMENT and the associated network-based tools enable the attachment of minimum permissions to copyrighted works and the subsequent on-line licensing of the media.

DOCUMENT 930 of FIG. 2 provides a secure container for electronic media, including heterogeneous multimedia data types such as musical scores coupled with graphical images. More particularly, the DOCUMENT 930 provides a package that encapsulates binary data objects, shown as the data container 933, and can contain some or all of the illustrated data components 931, 932, 934, 935 and 936.

The Document Identifier 932 uniquely identifies the DOCUMENT 930 by the registration server upon which the DOCUMENT has been registered, and the DOCUMENT's registration or index number on that server. This registration code typically contains the server name and registration index. A registration server cross-reference table, working in conjunction with the Internet's Domain Name Service (DNS), is used to find the actual network address (typically a TCP/IP address) of the registration server. In one embodiment of the invention, a work in progress is a locally accessible file which has not been authenticated through the registration process.

U.S. patent application No. 20010044781, which is incorporated herein by reference, discloses an interactive process and apparatus to expedite the licensing and management of content for communications projects. The process allows the user to streamline negotiation, implementation, and payment of licensing contracts related to multiple pieces of content from multiple content licensors by gathering, organizing, and utilizing project information, technical specification, and/or licensing terms. The apparatus allows the user to expedite several of the administrative tasks necessary to research, obtain, track and license content.

The process, as illustrated in FIG. 3, facilitates the licensing of content, management and tracking of content and other valuable materials during production, tracking of budget expenditures, management of technical requirements for content, compliance with contractual responsibilities, and the archiving of records. It can be divided into four sections, each based upon a family of tasks within the larger process.

Section A, the first steps of the process, include gathering and storing information necessary to efficiently communicate (and document that communication) with third parties, such as Content Vendors and service providers. Should the user choose to use the Electronic Storage Files to store this information, she could further expedite her work by creating templates to extract pertinent information from the Electronic Storage Files and organize it into correspondence, documentation, and report formats. As the Apparatus can access the same piece of information for multiple purposes, the user is able to enter each piece of information just once to create almost all of the administrative communications and records she will need. The Apparatus may also allow the user to electronically transmit correspondence, documentation, and reports directly to Content Vendors, project staff, and other third parties.

Section B of the process allows the user to track valuable materials, including but not limited to content, throughout the production procedures. The user records the submission information for each piece of or group of valuable materials she receives. She records similar information for each transfer and/or return of valuable materials. By creating records of all materials received, transferred to third parties, and returned to their source, the user can accurately account for all of the valuable materials she has received. By storing the submission, transfer, and return records within the Electronic Storage Files of the Apparatus, and using a template process similar to that in Section A, the user can create correspondence, documents, and reports to assist her in completing and documenting each submission, transfer, and return.

Section C of the process links the master, working, and manipulated content copies to their content data, technical specifications, and licensing terms. The user may then create a draft of her project using a design/editing system (shown here outside of the Apparatus), manipulating the content within it as she needs. Accessing the identification link within the manipulated content copy used in the draft, and matching it to the other content records, the Apparatus will then assist the user in quickly and easily reviewing the financial, contractual, and technical responsibilities and/or viability of her project draft. It will also assist her in creating production reports containing details for the design, such as credit line and storage location lists.

In Section D, when a design has been finalized, the user may employ the Apparatus to store the final pricing specifications for each piece of content. If the user has stored all of the administrative, contractual, technical, and use information electronically, she could also employ the Apparatus to create use notifications, using a template to access and organize pertinent information.

In addition, the user may record her compliance with licensing terms, such as payment information, in the Apparatus. The user may choose to link the Apparatus with other optional modules (such as accounting, shipping, printing, and/or project management systems) using the Communication Links, thus integrating the payment or and/or compliance with licensing terms with her own records.

The user may archive all of the project records. She may wish to include materials from other sections of the production process, such as copies of design layouts from design/editing systems or printing-press specifications. The user may choose to store the project records in electronic form (such as on a CD ROM), in hard copy form, or in a combination of both. The user may wish to archive the records within a larger archive that contains the records from other projects.

Finally, the user may wish to access the project records in the archive to review and make use of various details of the project at a later date. For example, she may verify compliance with licensing terms, create forms and documents to assist her in re-licensing content for later editions/variations of the project, create a series of reports comparing project or vendor information with similar information from other projects she has completed, and/or create estimates for new projects. When licensing terms and research fees have been agreed to, the user has the option of generating a contract which confirms the final licensing terms and assigns the contract a unique identification code.

U.S. Pat. No. 6,499,106 is incorporated herein by reference. The '106 patent discloses a method and system for securely distributing data recorded on high density fixed media such as compact discs (“CDs”). A central access control system copies sensitive information from a master set of one or more CDs and records the information on distribution CDs using an embedded data encryption process. In addition to the encrypted data, unique disc identification information is also recorded on each disc of each set of distribution CDs. The distribution disc sets are identical to each other and the master set but for the unique disc identification information which, in a preferred embodiment, is recorded in the R-W subchannels of the control bytes of the first sector of CD-R media.

The central access control system records, in a database, the disc identification information of each disc of each set of distribution CDs and a remote location access rights list (ARL). In addition, a list of unique remote location identification numbers are stored in the central access control database. The disc identification information of each CD is correlated with the intended recipient remote location. Thus, the central access control system is able to determine which remote location should be authorized to access which distribution CDs.

A distribution CD set is physically delivered to each remote location requiring access to the recorded information. Each remote location is equipped with an information access system that includes its unique remote location identification number, a CD reader with an embedded decryption system, and a bilateral communication link to the central access control system. When a user wishes to access the information, he logs into the information access system using his unique user identification and password pair. The information access system then reads the disc identification information and sends its unique remote location identification number and the disc identification information as an access request to the central access control system via the bilateral communication link. If the access control system is able to verify the request based on the central access control database and grant the request based on the ARL, the central access control system will send the requesting information access system a unique decryption key to access the particular distribution CD currently contained in the information access system.

In FIG. 4, a block diagram depicting a layout of an embodiment of the disc identification information 940 is provided. The central access control system can track an trace which duplicated CD disc goes to which information access system at a branch office. This tracking and tracing is achieved through the disc identification information 940 recorded directly on the CD media. The program in the central access control system is configured to write to the R-W subchannels of the control bytes of the first sector of a recordable disc. There are 98 control bytes in this sector with the R-W occupying Bit 0 through Bit 5 of each byte. Following the first 2 bytes 942, there are 64 six bit words available for user data contained within four groups 944, 948, 952, 956 of 24 bytes. There are 16 six bit words within the first group of 24 bytes 944 that are used for central access control system 100 designated Volume numbers 946, within the next group of 24 bytes 948, there are 16 six bit words that are used for disc ID numbers 950, and within the remaining two groups of 24 bytes 952, 956 (48 bytes total) there are 32 six bit words that are used for Serial numbers 954, 958.

Using the SCSI-3 “WRITE PARAMETER” command, the Volume numbers 946, the disc ID numbers 950, and the Serial numbers 954, 958 are recorded in the user data area. In a preferred embodiment, the characters and numbers that are used to represent the disc identification information 940 are taken from the Transcode character set. The transcode character set includes the necessary alphabets (of a number of languages) in upper case, numbers, and some control characters. Use of the Transcode character set eliminates the need to perform shift-pack and shift-unpack of the six bit words when reading and writing to and from the CD media. As described above the disc identification information 940 is used by the information access systems 130, 140, 150 to request decryption keys from the central access control system 100.

U.S. Pat. No. 6,434,535 is incorporated herein by reference. The '535 patent discloses a system and method for distribution of electronic content over a network infrastructure and compensation of vendors of such data using prepaid media that includes a client device for operation by a user desiring to receive the electronic content and server that contains the electronic content and offering the electronic content for downloading to the client device via the network infrastructure. The client device communicates a unique identifier associated with a particular piece of media to which the electronic content is to be stored to the server. The server contacts a media tracking sever to determine if the media is valid and a remaining balance of the prepaid media. The cost of the electronic content to be downloaded is deducted from the remaining balance and credited to the vendor's account. The server then encrypts the electronic content using the unique identifier as a key and downloads the encrypted electronic content to the client computer, where the client computer writes the encrypted electronic content to the particular piece of media such that the encrypted electronic content may only be accessed from the particular piece of media. The electronic content is only accessible from only the one piece of media having the unique identifier and is not accessible from any other media having a different or no identifier.

FIG. 5 illustrates by which a customer selects and downloads electronic content using prepaid media. The user initiates the electronic data distribution process at step 960 when he or she desires to purchase software, music or videos (i.e., protected electronic data) using a home personal computer or stand alone device.

After receiving the first command packet, at step 966, the server contacts the media tracking server to verify that the media's unique identifier is valid and that there is a sufficient balance to cover the cost of the content to be downloaded. The media tracking server 16a then looks-up the unique identifier at step 968 in the tracking database, and at step 970, determines the remaining balance. At step 972, the media tracking server determines if the remaining balance is greater than the purchase price of the electronic content. If the remaining balance is greater than the purchase price of the electronic content, then at step 974 the media tracking server responds to the E-commerce server with a positive acknowledgment at step 973, debits the purchase price from the remaining balance associated with the unique identifier, and credits the E-commerce entity's account with the purchase price amount.

None of the prior art discloses a format for a standard release and/or license identifier for uniquely identifying releases and/or licenses or metadata associated with particular releases and/or licenses.

What is desired is the use of standard identifiers related to the release of data and/or copyrighted data, and the licensing of the data and/or copyrighted data contained in the releases to increase the efficiency in the exchange of release and license related metadata.

### SUMMARY OF THE INVENTION

It is one feature and advantage of the present invention to have preferably standard and/or substantially standard release and/or license identifiers having formats that allow for identification of releases and/or licenses.

It is another optional feature and advantage of the present invention to have preferably standard and/or substantially standard release and/or license identifiers that include a check character to protect integrity of the release and/or license identifier as it is disseminated.

It is another optional feature and advantage of the present invention to have preferably standard and/or substantially standard release and/or license identifiers that facilitates accurate and timely identification of releases and/or licenses to enable the efficient and timely tracking and/or processing of use, transactions and/or revenue associated with the releases and/or licenses.

It is another optional feature and advantage of the present invention to have preferably standard and/or substantially standard release and/or license identifiers that enable retrieval of identifying and/or descriptive information pertaining to releases and/or licenses.

It is another optional feature and advantage of the present invention to have preferably standard and/or substantially standard release and/or license identifiers that can be applied to both physical and electronic distributions of releases and/or associated licenses.

It is another optional feature and advantage of the present invention to have preferably standard and/or substantially standard release and/or license identifiers that provide a mechanism for identifying legitimately released and/or licensed content.

These and other features and advantages of the present invention are achieved in a memory storing a data structure that comprises release identifier information relating to identification, validation, authorization, and/or use of data, including a data arrangement, a data collection, and/or a data set. The data structure also includes at least one intellectual property right associated with the data. The data structure is retrieved from the memory responsive to instructions implemented by a data processor and/or a computer. The data structure further includes a first data element that includes an issuer code, a second data element that includes an intellectual property bundle number, and a third data element that includes a check character. The first, second, and third data elements are used in the identification, validation, authorization, and/or use of the data.

In another embodiment of the present invention, a memory stores a data structure that includes license identifier information relating to identification, validation, authorization, and/or use of data, including a data arrangement, a data collection, and/or a data set. The data structure also includes at least one intellectual property right associated with the data. The data structure is retrieved from the memory responsive to instructions implemented by a data processor and/or a computer. The data structure further includes a first data element that includes an issuer code, a second data element that includes a license reference, and a third data element that includes a check character. The first, second, and third data elements are used in the identification, validation, authorization, and/or use of the data.

In another alternative embodiment of the present invention, a memory stores a data structure that includes release identifier information relating to identification, validation, authorization, and/or use of data, including a data arrangement, a data collection, and/or a data set. The data structure also includes at least one intellectual property right associated with the data. The data structure is retrieved from the memory responsive to instructions being implemented by a data processor and/or a computer. The data structure further includes a first data element that includes an identifier scheme, which has two valid characters. The data structure also includes a second data element that includes an issuer code, which has five valid characters. The first data element preferably precedes the second data element. The data structure further includes a third data element that includes an intellectual property bundle number, which has seven valid characters in one embodiment. The second data element preferably precedes the third data element. The data structure optionally also includes a fourth data element that includes a delivery attribute extension, which, for example, has three valid characters. The third data element preferably precedes the fourth data element. In another embodiment, the intellectual property bundle number includes the delivery attribute extension and is, thus, ten valid characters in length. A valid character is one of any upper case letter of the Roman alphabet, excluding “I” and “O”, and any Arabic digit and is preferably defined using ASCII codes. The data structure further includes a fifth data element that includes a check character, which has one character. The one character preferably is any upper case letter of the Roman alphabet or any Arabic digit and preferably is defined using ASCII codes. The fourth data element preferably precedes the fifth data element.

In another embodiment of the present invention, a memory stores a data structure that includes license identifier information relating to identification, validation, authorization, and/or use of data, including a data arrangement, a data collection, and/or a data set. The data structure includes at least one intellectual property right associated with the data. The data structure is retrieved from the memory responsive to instructions implemented by a data processor and/or a computer. The data structure further includes a first data element that includes an identifier scheme, which has two valid characters. The data structure also includes a second data element that includes an issuer code, which has five valid characters. The first data element preferably precedes the second data element. The data structure further includes a third data element that includes a license reference, which has seven valid characters in one embodiment. The second data element preferably precedes the third data element. The data structure optionally also includes a fourth data element that includes a society auxiliary extension, which, for example, has three valid characters. The third data element preferably precedes the fourth data element. In another embodiment, the license reference includes the society auxiliary extension and is, thus, ten characters in length. The data structure further includes a fifth data element that includes a check character, which has one character. The character preferably is any upper case letter of the Roman alphabet or any Arabic digit and is defined using ASCII codes. The fourth data element preferably precedes the fifth data element.

In another embodiment of the present invention, a method is provided for managing identification and description of at least one release. The method includes determining the contents of the at least one release and obtaining at least one release identifier associated a particular release. The method also includes obtaining musical work details associated with the contents of the at least one release, and compiling at least one label copy, wherein the at least one label copy comprises the contents of the at least one release, the at least one release identifier, and the musical work details.

In another embodiment of the present invention, a method for managing identification and description of at least one license associated with at least one release includes notifying at least one licensing entity of the at least one release and determining the terms of the at least one license. The terms of the license preferably are negotiated between the at least one licensing entity and at least one issuer entity that issues the at least one release. The method also includes obtaining at least one license identifier associated with a unique one of the at least one license.

In another embodiment of the present invention, a method for administering a release identifier includes issuing at least one issuer code, which is issued by a central registration service and is assigned to a particular issuing entity. The method also includes issuing at least one release having a release identifier that includes the at least one issuer code. The at least one release is issued by the particular issuing entity that was assigned the issuer code.

In another alternative embodiment of the present invention, a method for administering a license identifier includes issuing at least one issuer code, which is issued by a central registration service and is assigned to a particular licensing entity. The method also includes issuing at least one license having a license identifier that includes the at least one issuer code. The at least one license is issued by the licensing entity that was assigned the issuer code.

In another embodiment of the present invention, a method for exchanging information regarding at least one release includes converting, by a first entity, a release identifier and metadata associated with the at least one release from a first proprietary format associated with the first entity into a standard format. The standard format comprises a standard metadata schema. The method also includes mapping, by the first entity, the release identifier and the metadata associated with the at least one release into appropriate fields within the standard metadata schema. The method further includes transmitting the release identifier and metadata from the first entity to a second entity, and converting, by the second entity, the release identifier and the metadata associated with the at least one release from the standard format into a second proprietary format associated with the second entity. The release identifier and the metadata identify and describe the at least one release.

In another alternative embodiment of the present invention, a method for exchanging information regarding at least one license includes converting, by a first entity, a license identifier and metadata associated with the at least one license from a first proprietary format associated with the first entity into a standard format. The standard format comprises a standard metadata schema. The method also includes mapping, by the first entity, the license identifier and the metadata associated with the at least one license into appropriate fields within the standard metadata schema. The method further includes transmitting the license identifier and metadata from the first entity to a second entity, and converting, by the second entity, the license identifier and the metadata associated with the at least one license from the standard format into a second proprietary format associated with the second entity. The license identifier and the metadata identify and describe the at least one license.

There has thus been outlined, rather broadly, the more important features of the invention and several, but not all, embodiments in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These, together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 illustrates a prior art application of an information repository to enterprise data modeling;

FIG. 2 illustrates a prior art system for secure electronic copyright management;

FIG. 3 illustrates a prior art process for expediting the licensing and management of content for communications projects;

FIG. 4 illustrates a block diagram depicting a layout of a prior art disc identification information;

FIG. 5 illustrates a prior art method by which a customer selects and downloads electronic content using prepaid media;

FIG. 6 illustrates a model for a relationship between release and license identification systems according to the present invention;

FIG. 7 is a flow chart diagram illustrating a method for management of the identification and description of releases and licenses according to the present invention;

FIG. 8 is a flow chart diagram illustrating a method for the exchange of release and/or license information according to the present invention;

FIG. 9A is an illustration of a release identifier according to the present invention;

FIG. 9B is an illustration of another embodiment of release identifier according to the present invention;

FIG. 10 illustrates an example of the structure for a release containing a multi-asset intellectual property bundle;

FIG. 11A is an illustration of a license identifier according to the present invention;

FIG. 11B is an illustration of a license identifier according to the present invention;

FIG. 12 illustrates a process for assigning issuer codes according to the present invention;

FIGS. 13A and 13B illustrate an example of fields in a transaction message for an inter-company sales reporting transaction;

FIGS. 14A, 14B, and 14C illustrate an example of fields in a transaction message for a retail notification transaction;

FIG. 15 illustrates an example of a navigational view feature for a release;

FIG. 16 illustrates another example of a navigational view feature for a release;

FIGS. 17A, 17B, and 17C illustrate an example of fields in a transaction message for a release notification licensing transaction;

FIGS. 18A, 18B, and 18C illustrate an example of fields in a transaction message for a release confirmation licensing transaction;

FIG. 19 is a diagram of an information architecture to support access to release and license metadata according to the present invention; and

FIG. 20 is a diagram of an communications network for accessing release and license metadata according to the present invention.

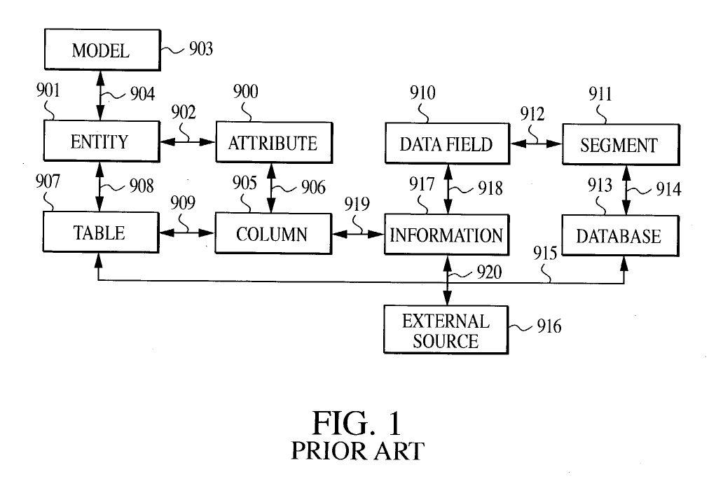

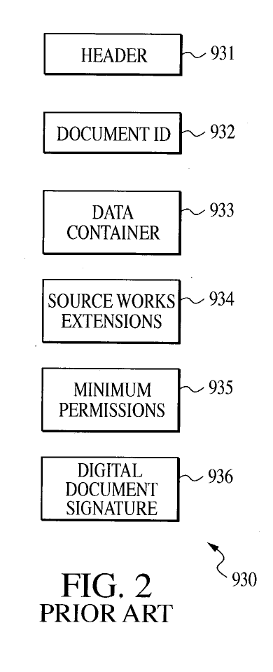

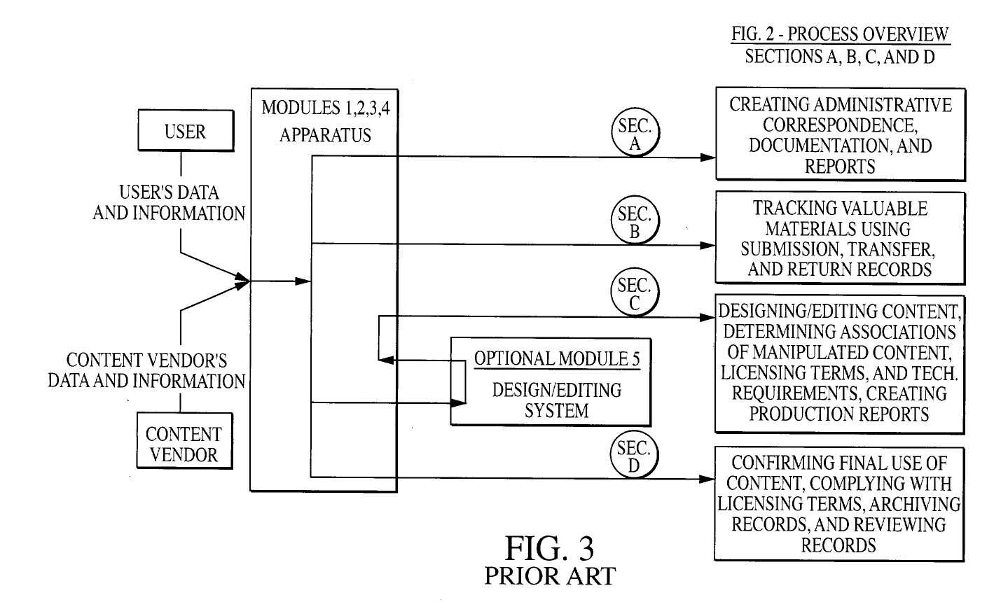

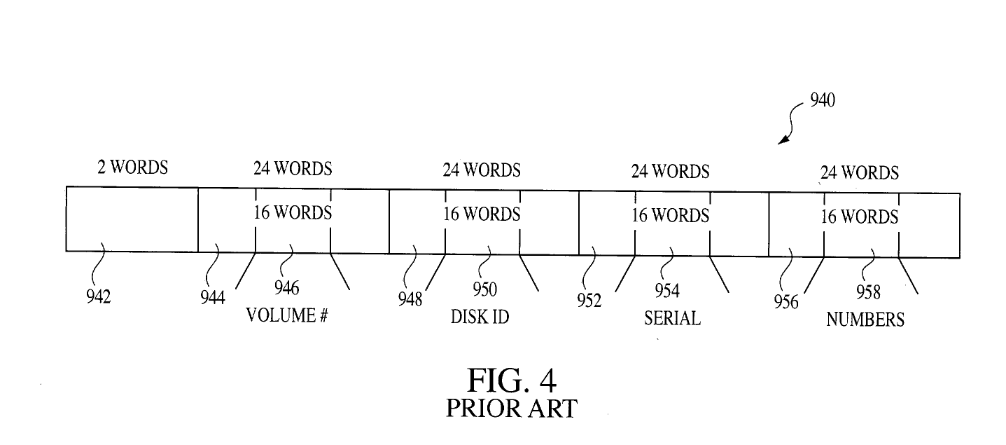

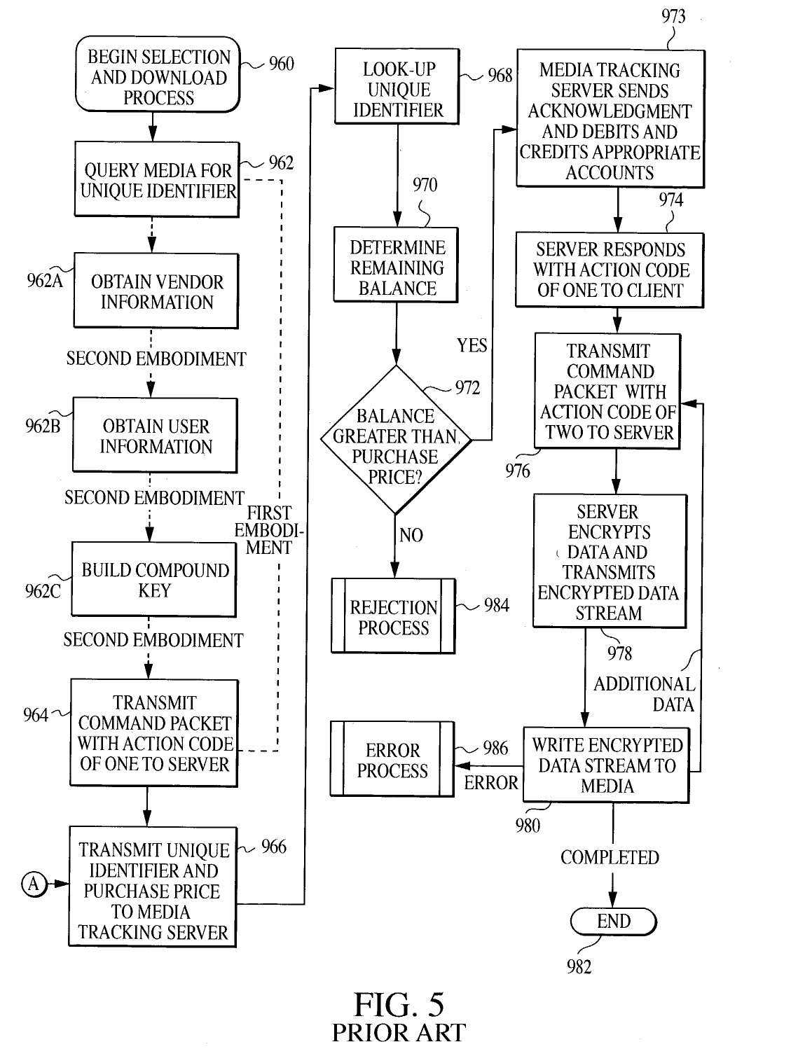

### DESCRIPTION OF THE PREFERRED EMBODIMENTS

Reference now will be made in detail to the presently preferred embodiments of the invention. Such embodiments are provided by way of explanation of the invention, which is not intended to be limited thereto. In fact, those of ordinary skill in the art may appreciate upon reading the present specification and viewing the present drawings that various modifications and variations can be made.

For example, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

In accordance with one embodiment of the invention, different music rights societies (“societies”) and record companies depend upon their ability to accurately identify musical works and sound recordings to respectively license musical works and release sound recordings and products containing these sound recordings. The parties incur significant costs from the business processes associated with the task of uniquely identifying a musical work and a sound recording whenever music is “used.” Within the databases of many music industry organizations, sound recording information is linked to musical work information to enable, for example, identification. However, it has been determined that accurate identification frequently is not achieved due to the lack of standard identification systems and inconsistent descriptive metadata. We also have determined that the ability to accurately identify sound recordings and musical works is greatly improved, in accordance with one embodiment of the invention, by linking release identifiers to license identifiers, in conjunction with linking International Standard Recording Codes (ISRCs) to International Standard Musical Work Codes (ISWCs) to establish the relationship between a musical work and the sound recordings on which it appears.

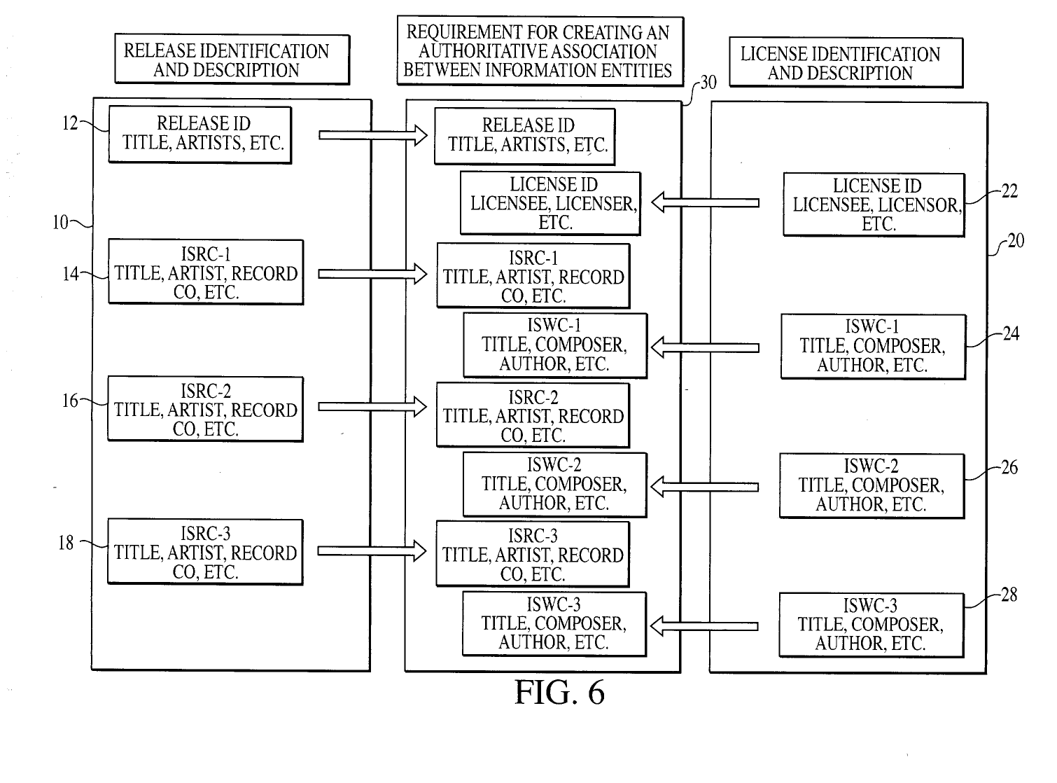

FIG. 6 illustrates a functional interaction or model for the relationship between identification systems to create an association between information entities. A release identification and description implementation 10 comprises, for example, release identifier 12 and several ISRCs 14, 16, and 18. Release identifier 12 identifies, for example, the title, artist, etc. of a release. ISRCs 14, 16, and 18 identify, for example, the title, artist, record company, etc. for various sound recordings included in the Release. Alternative data and/or copyrighted data may be identified by release identifier 12, as well.

A license identification and description implementation 20 comprises, for example, license identifier 22 and several ISWCs 24, 26, and 28. License identifier 22 identifies, for example, the licensee, licensor, etc. of data and/or copyrighted data, such as a musical work. ISWCs identify, for example, the title, composer, author, etc. for various other musical works. Information entity association 30 comprises the joining of release and related licensing information for sound recordings and musical works. For example, release identifier 12 and license identifier 22 join to identify the complete relationship between the release and musical work identified by release identifier 12 and license identifier 22, respectively.

One means of achieving both the association between information entities and to provide for appropriate access to release and license information is to associate information regarding licenses and the data, such as musical works, within unencrypted information fields of release file formats. Certain information is preferably carried in the unencrypted information fields to enable, for example: license verification; anti-piracy; documentation for identification purposes; and usage monitoring.

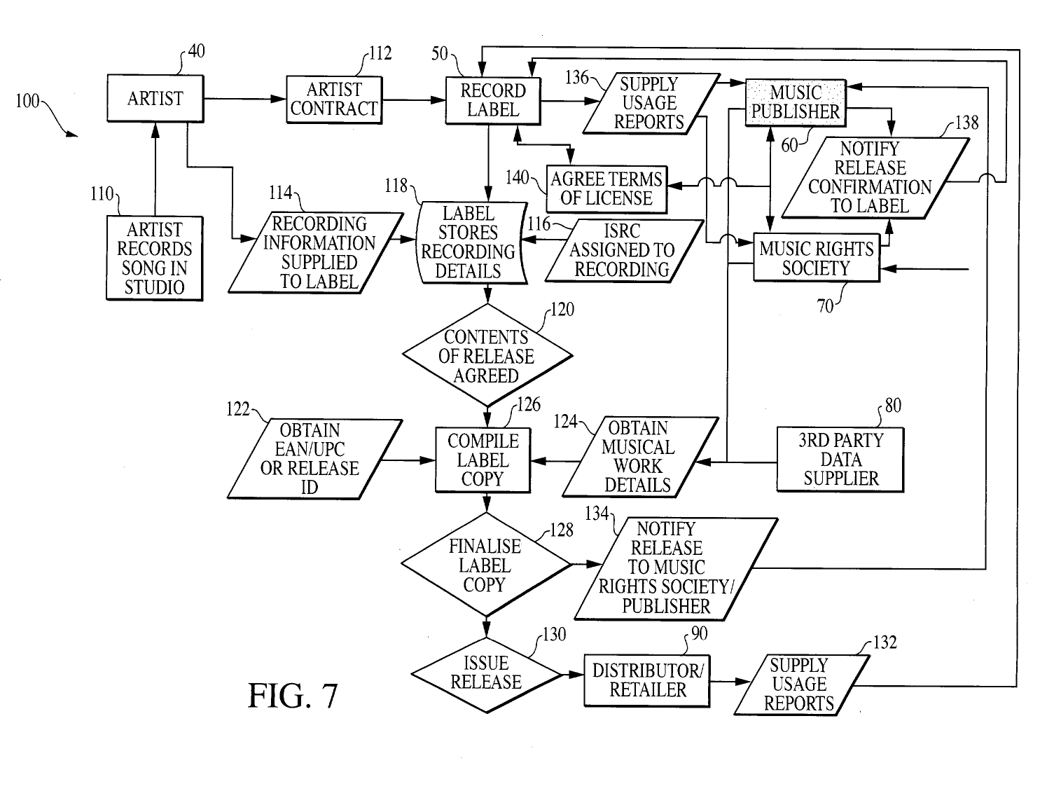

In accordance with one embodiment of the invention, where the data comprises musical works, FIG. 7 is a flow chart diagram illustrating management of the identification and description of releases and sound recordings by record companies, as well as management of the identification and description of musical works and licenses by societies, denoted generally by reference numeral 100. In this embodiment, several entities are involved in management process 100, including, for example: artist(s) 40; record label(s) 50; music publisher(s) 60; society or societies 70; third party data supplier(s) 80; and distributor(s)/retailer(s) 90.

Management process 100 begins when artist 40 records a musical work, e.g., a song, in a studio, for example, step 110. Artist 40 then contracts with a record label 50, for instance, to market and distribute the song, step 112. Artist 40, or some other entity, provides the recording information details to record label 50, step 114. A standard ISRC is also optionally assigned to the recording, step 116. Record label 50 then stores the recording information details, along with the ISRC if assigned, step 118.

The concerned parties, including artist 40 and record label 50, subsequently agree on the contents of a proposed release, step 120. A release identifier is then assigned to the release, step 122. Optionally, a standard European Article Number (“EAN”), for Europe and other territories, and/or a standard Universal Product Code (“UPC”), for the US and Canada, may be assigned to the release. The descriptive details regarding the musical work are also obtained from music publisher 60 and/or third party data supplier 80, step 124. Using the identification and descriptive information for the release and its associated musical works, record label 50 compiles a label copy, step 126. A label copy is literally the “copy” or words that are used on the label of the physical embodiment of a release, e.g., C lines, or copyright notices, P notices, or performance rights notices, etc. The label copy is also used by record label 50 to describe the product, for example, whether the release is a single or an album. The label copy is also used by licensing entities as a main source of information regarding the release, for example, performance rights societies. Furthermore, repertoire and product database providers also often retrieve necessary information from the label copy for their respective operations.

After the label copy is compiled, record label 126 then can finalize the label copy, step 128, and then issue the release to a distributor/retailer 90, step 130. Distributor/retailer 90 supplies usage reports to record label 50. Other entities may optionally be responsible for supplying usage reports to record label 50. Record label 50, or some other entity, in turn, supplies the usage reports to society 70 and/or music publisher 60, step 136.

Record label 50 notifies society 70 and/or music publisher 60 of the release, step 134, which begins the licensing process. Society 70 and/or music publisher 60 sends a confirmation to record label 50 that notification of the release has been received, step 138. Record label 50 then negotiates the terms of a license of any musical work or works contained within the release with society 70 and/or music publisher 60, step 140. In an alternate embodiment, record label 50 may negotiate the license with some other entity, which then negotiates with society 70 and/or music publisher 60. Other inter-entity information processes may occur other than those described above. Additionally, each society 70 may have its own individual processes that vary from those represented in FIG. 7 and may not manage information about sound recordings and their relationship with musical works to the same level of detail.

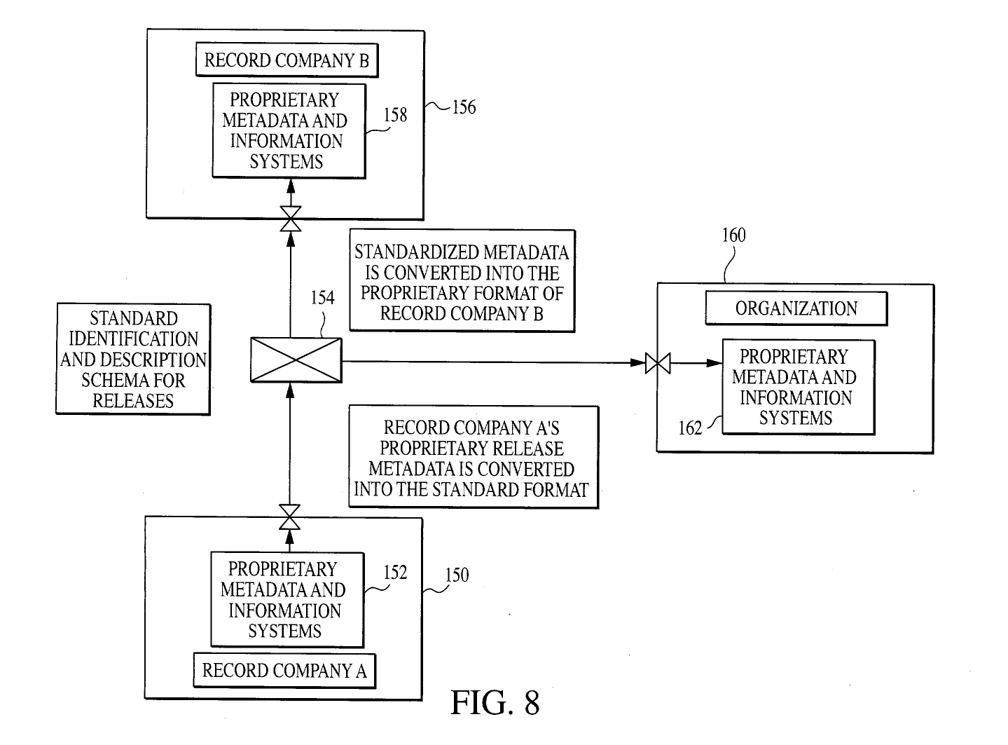

FIG. 8 is a flow chart diagram illustrating a method for exchanging information regarding releases and/or licenses using standardized metadata. For example, Record Company A 150 wishes to issue an identifier and descriptive information for a release. The metadata and identifiers are initially held in proprietary metadata and information systems 152 of Record Company A 150. The metadata and identifiers are mapped to the appropriate fields 154 within a standard metadata schema (see Appendix A) for a Release. Any coded values are translated from proprietary to the standardized versions. The standardized identifiers and metadata are preferably expressed in an extensible mark-up language (“XML”)-type message and delivered to external organizations, for example Record Company B 156 and/or Organization 160.

Record Company B 156 maps the standardized fields 154 of metadata and identifiers to its own proprietary data descriptions and codes that are recognized in its information systems 158. The translation process is then duplicated by each organization 160 that needs to process the release information. This method also applies to the transfer of license information between organizations.

I. Release and License Identifiers

A. Release Identifiers

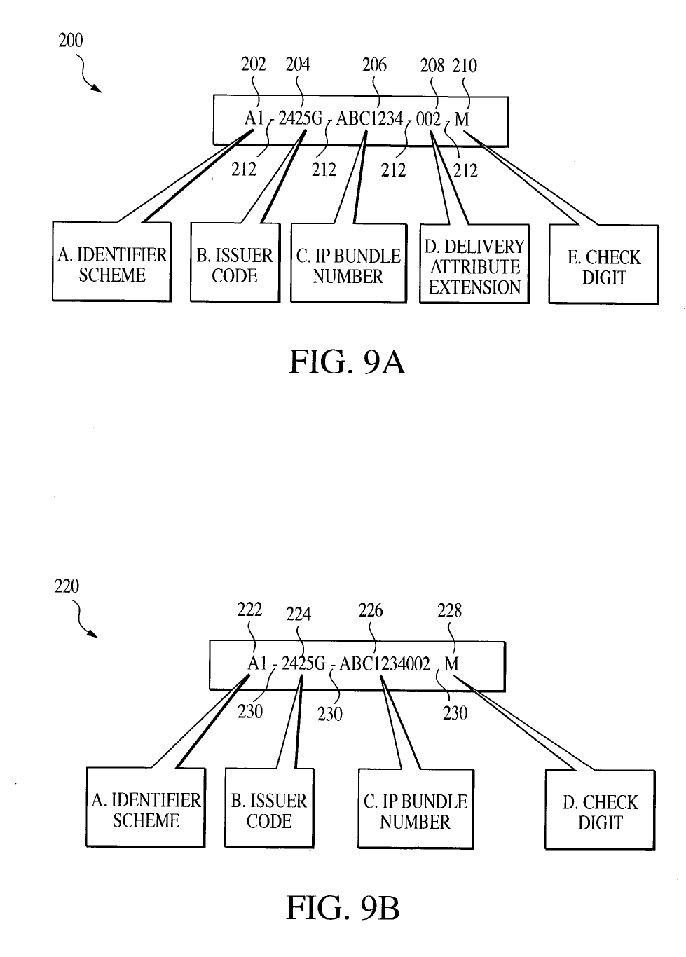

FIG. 9A illustrates a format for a release identifier. A release identifier (“ID”) preferably is used to identify releases, which can contain single or multiple intellectual property assets, including, for example, sound recordings, text, images, video, and software. Release ID 200 comprises an issuer code 204, an intellectual property (“IP”) bundle number 206, and a check character 210. Release ID 200 also optionally includes Release identifier scheme 202 and/or delivery attribute extension 208.

Release ID 200 preferably is of the form A-B-C-D-E, where each of the five elements preferably is separated by a hyphen 212, “-”. Several elements preferably are formed of “valid characters.” A “valid character” is either any upper case letter of the Roman alphabet, except for “I” or “O” (to avoid ambiguities with the Arabic numbers one and zero) or any Arabic digit. Therefore, there are 34 valid characters. A valid character preferably is coded as defined in the International Reference Version (IRV) of ISO 646 (incorporated herein by reference), which is equal to, or consistent with, ASCII codes. Release ID 200, as illustrated in FIG. 9, is an example of the structure of a typical release ID. The size of release ID 200 is preferably 18 characters. Other formats and sizes for release ID 200 apply to alternative embodiments.

Release identifier scheme 202 uniquely identifies the identification scheme, for example, the release ID for the record industry, from any other identification scheme adopting the same structure that might be used to identify releases of other content types. Release identifier scheme 202 preferably comprises two valid characters. In this example, the release identifier scheme is “A1”, however, release identifier scheme 202 may be any combination of, for example, two valid characters, i.e., “A2 to “A0” and “AA” to “ZZ”. Other formats and/or numerical or character compositions for release identifier scheme 202 may optionally be used.

Issuer code 204 uniquely identifies the entity responsible for issuing a release ID 200. Issuer code 204 preferably comprises five valid characters, although other formats are possible. IP bundle number 206 is allocated uniquely by an entity that has been assigned an issuer code 206 to identify the collection of IP assets and their accompanying descriptive metadata associated with each release. IP bundle number 206 preferably comprises seven valid characters, although other formats are possible.

Delivery attribute extension 208 optionally is allocated uniquely by a an entity that has been assigned an issuer code 204 to distinguish between different versions of a release where an IP bundle remains the same but the parameters relating to the trade of the different versions need to be distinguished. The parameters indicated by delivery attribute extension 208 typically have no material impact on the intellectual property with the IP bundle. In one embodiment, entities issuing IP bundle numbers are free to choose whether or not they wish to differentiate between the different delivery attributes, which might relate to the same IP bundle. Therefore, delivery attribute extension 208 is optional. Delivery attribute extension 208 preferably comprises three valid characters, although other formats are possible.

An optional, check character 210 is calculated for each release identifier 200 to ensure that release ID 200 has been correctly entered into a computer system, a database, or some other system that enables the management and dissemination of release information. Check character 210 preferably is calculated in accordance with “ISO 7064:1983 (incorporated herein by reference), as described below in more detail. Check character 210 preferably comprises one alphanumeric character. Check character 210, as calculated under ISO 7064:1983, may lead to any letter (including “I” or an “O”).

Release ID 200 may have several alternative formats. In one alternative embodiment, release ID 200 is of the form B-C-D-E, i.e., without Release identifier scheme 202) when it is obvious to all concerned entities which identifier scheme is being used. In another alternative embodiment, release ID 200 is of the form ABCDE, i.e., without hyphens 212 separating the elements, which it is obvious to all concerned entities that the code is a release ID. In a further alternative embodiment, release ID 200 is of the form BCDE, i.e., without release identifier scheme 202 and without hyphens 212, when it is obvious to all concerned entities that the code is a release ID and which identifier scheme is being used.

FIG. 9B illustrates an alternate format for a release identifier. Release ID 220 comprises an issuer code 224, an IP bundle number 226, and a check character 228. Release ID 200 also optionally includes Release identifier scheme 222. In this embodiment, IP bundle number 226, which is ten characters in length, contains information regarding a delivery attribute in addition to information regarding the intellectual property rights associated with the release. Therefore, a delivery attribute extension may be omitted.

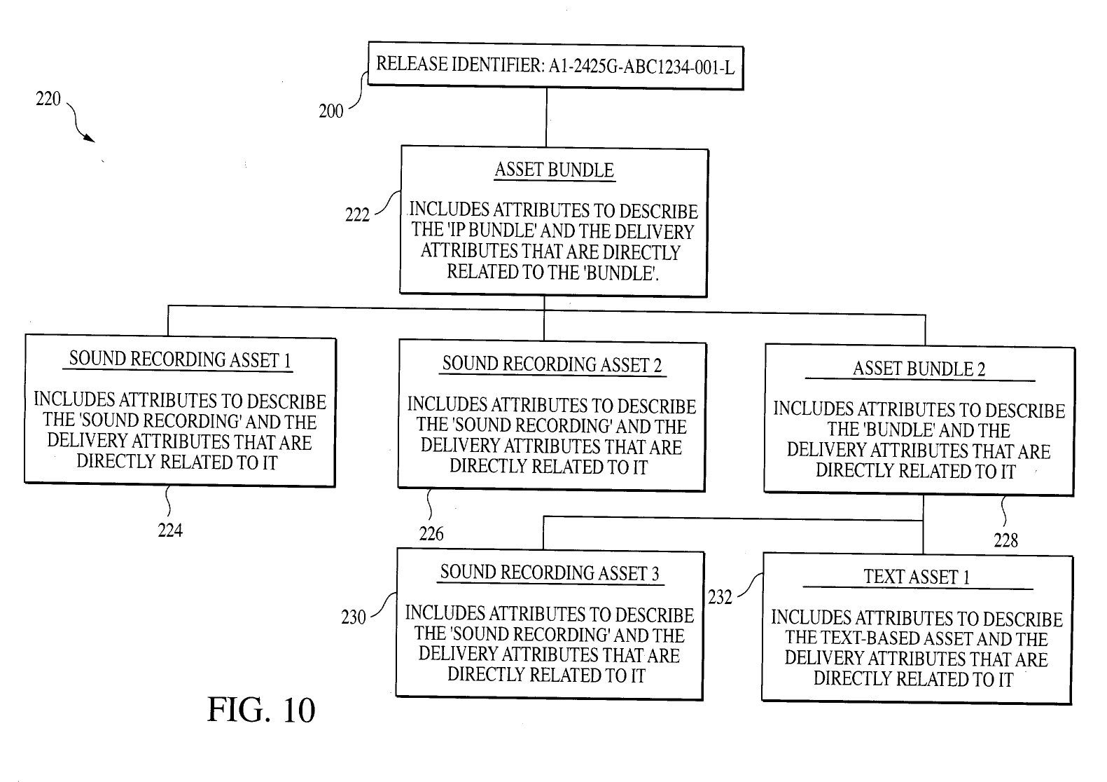

FIG. 10 illustrates the structure for an example release containing a multi-asset IP bundle. Release 220 is identified by a unique release ID 200, as described previously. Release 220 has an IP or asset bundle 222, which consists of two sound recordings, sound recording asset 224 and sound recording asset 226. IP bundle 222 also includes an additional IP bundle 228, referred to as a “sub-bundle” to illustrate the possible, hierarchical structure of IP bundles. IP bundle 228, or sub-bundle, includes sound recording asset 230 and text asset 232. IP bundle 222 is uniquely identified by the IP bundle number of release ID 200, in this example, “ABC1234”.

B. License Identifiers

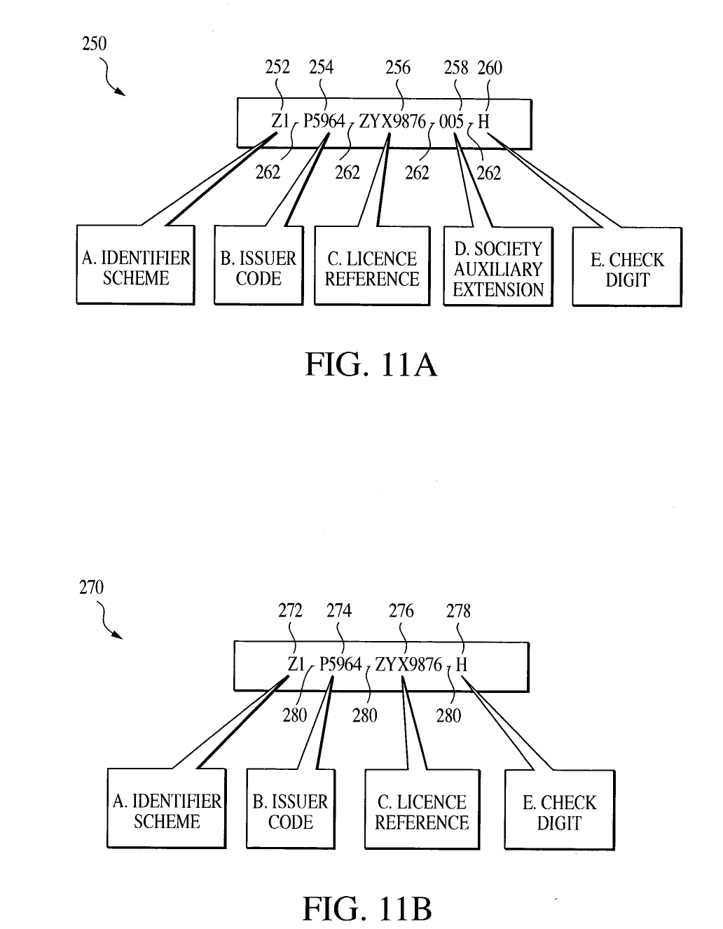

FIG. 11 illustrates a preferred format for a license identifier. A license identifier (“ID”) is preferably used to identify licenses, relating to electronic music delivery releases and other products, for example, embodying musical works. In one embodiment, license ID 250 comprises an issuer code 254, a license reference 256, and a check character 260. License ID 250 also optionally includes identifier scheme 252 and/or society auxiliary extension 258.

License ID 250 is preferably of the form A-B-C-D-E, where each of the five elements is separated by a hyphen 262, “-”. Several elements preferably are formed of “valid characters,” as described previously. License ID 250, as illustrated in FIG. 11, is an example of the structure of a typical license ID. The size of license ID 250 is preferably 18 characters. Other formats and sizes for license ID 250 apply to alternative embodiments.

License identifier scheme 252 uniquely identifies the identification scheme, for example, the license ID for licenses issued with respect to musical works, from any other identification scheme adopting the same structure that might be used to identify other content types. License identifier scheme 252 preferably comprises two valid characters. In this example, the license identifier scheme is “Z1”, however, license identifier scheme 252 may be any combination of, for example, two valid characters, i.e., “Z2” to “Z0” and “ZA” to “ZZ”. Other formats and/or numerical or character compositions for license identifier scheme 252 may optionally be used.

Issuer code 254 uniquely identifies the entity responsible for issuing a license ID 250. Issuer code 254 preferably comprises five valid characters, although other formats are possible. License reference 256 is allocated uniquely by an entity that has been assigned an issuer code 256 to identify a license and its accompanying metadata. License reference 256 preferably comprises seven valid characters, although other formats are possible.

Society auxiliary extension 258 optionally is allocated uniquely by an entity that has been assigned an issuer code 254 to distinguish between different versions of a license. Society auxiliary extension 258 may be used for a range of applications needed to distinguish or link licenses. For example, an organization issuing license IDs may use society auxiliary extension 258 as an additional means (other than the license ID's metadata) to identify specific licensees, so that all licenses issued to a specific licensee will have the same society auxiliary extension 258 but different license references 256. Alternatively, society auxiliary extension 258 may be used to distinguish licenses where all the terms and conditions are identical except, for example, the period of the license. Entities issuing license references are free to choose whether or not they wish to use society auxiliary extension 258 as a means of differentiating or linking license references. Therefore, society auxiliary extension 258 is optional. Society auxiliary extension 258 preferably comprises three valid characters, although other formats are possible.

An optional check character 260 is calculated for each license identifier 250 to ensure that license ID 250 has been correctly entered into a computer system, a database, or some other system that enables the management and dissemination of license information. Check character 260 preferably is calculated in accordance with “ISO 7064:1983 (incorporated herein by reference), as described below in more detail. Check character 210 preferably comprises one alphanumeric character. Check character 210, as calculated under ISO 7064:1983, may lead to any letter (including “I” or an “O”).

License ID 250 may have several alternative formats. In one alternative embodiment, license ID 250 is of the form B-C-D-E, i.e., without License identifier scheme 252) when it is obvious to all concerned entities which identifier scheme is being used. In another alternative embodiment, license ID 250 is of the form ABCDE, i.e., without hyphens 262 separating the elements, which it is obvious to all concerned entities that the code is a license ID. In a further alternative embodiment, license ID 250 is of the form BCDE, i.e., without license identifier scheme 252 and without hyphens 262, when it is obvious to all concerned entities that the code is a license ID and which identifier scheme is being used.

FIG. 11B illustrates an alternate format for a release identifier. In an alternate embodiment, license ID 270 comprises an issuer code 274, a license reference 276, and a check character 278. License ID 270 also optionally includes identifier scheme 272. In this embodiment, a society auxiliary extension is omitted. In another alternate embodiment license reference 276 may contains information regarding a society auxiliary extension, and thus be ten characters in length.

C. Check Character Calculation

Release ID check character 210 and license ID check character 260 are preferably calculated according to ISO 7064:1983 (“ISO 7064”), although alternative methods of calculation are possible. In one embodiment when ISO 7064 is used, ISO 7064 maps, for example, a string of alphanumeric characters (comprising the 26 Roman letters and 10 Arabic digits, and therefore being a superset of the valid characters used for composing Release and License Identifiers) to, for example, a single alphanumeric character.

The characters of the release ID or license ID are processed, optionally, character by character from left to right. n=18 is defined as the preferably number of characters including the check character in the release ID or license ID. The characters of the release ID or license ID (including the check character) are numbered, for example, from right to left such that a₁ is check character, and a₂ to a₁₈ are the characters of the release ID or license ID as follows, using release ID 200 in FIG. 9 as an example:

| | | | | | | | | | | | | | | | | | |
|---|---|---|---|---|---|---|---|---|---|---|---|---|---|---|---|---|---|
| A | 1 | 2 | 4 | 2 | 5 | G | A | B | C | 1 | 2 | 3 | 4 | 0 | 0 | 2 | X |
| a₁₈ | a₁₇ | a₁₆ | a₁₅ | a₁₄ | a₁₃ | a₁₂ | a₁₁ | a₁₀ | a₉ | a₈ | a₇ | a₆ | a₅ | a₄ | a₃ | a₂ | a₁ |

The counter aⱼ for j=n . . . 2 is set such that aₙ is the value for the first character of the release ID or license ID (see Table 1), aₙ₋₁ is the value for the second character of the release ID or license ID, etc. a₂ is the last character in the release ID before the check character. Setting j=1 and P₁=36, Sⱼ and Pⱼ₊₁ are calculated as follows:

Sⱼ=Pⱼ|₃₇+aₙ₋ⱼ₊₁

Pⱼ₊₁=Sⱼ∥₃₆*2

for j=1. . . n. ∥₃₆ is the remainder after division of Sⱼ by 36. If the remainder equals zero, then ∥₃₆=36. |₃₇ is the remainder after division of Pⱼ by 37 (never equals to 0). aₙ₋ⱼ₊₁ is the value of a character in the release ID or license ID string.

TABLE 1
Character Table for ISO 7064

| Char | Value |
|---|---|
| 0 | 0 |
| 1 | 1 |
| 2 | 2 |
| 3 | 3 |
| 4 | 4 |
| 5 | 5 |
| 6 | 6 |
| 7 | 7 |
| 8 | 8 |
| 9 | 9 |
| A | 10 |
| B | 11 |
| C | 12 |
| D | 13 |
| E | 14 |
| F | 15 |
| G | 16 |
| H | 17 |
| I | 18 |
| J | 19 |
| K | 20 |
| L | 21 |
| M | 22 |
| N | 23 |
| O | 24 |
| P | 25 |
| Q | 26 |
| R | 27 |
| S | 28 |
| T | 29 |
| U | 30 |
| V | 31 |
| W | 32 |
| X | 33 |
| Y | 34 |
| Z | 35 |

The check character a₁ is computed so that S₁₈∥₃₆=1. Table 1 then is used to select the calculated check character. An example, using release ID 200 (FIG. 9), follows (for n=18 and P₁=36):

| | | Char | | | | | | |
|---|---|---|---|---|---|---|---|---|
| j | Char | Value | aₐ₋ⱼ₊₁ | Pⱼ | Pⱼ\|₃₇ | Sⱼ | Sⱼ\|\|₃₆ | Pⱼ₊₁ |
| 1 | — | — | 10 | 36 | 36 | 46 | 10 | 20 |
| 2 | 2 | 2 | 1 | 20 | 20 | 21 | 21 | 42 |
| 3 | 0 | 0 | 2 | 42 | 5 | 7 | 7 | 14 |
| 4 | 0 | 0 | 4 | 14 | 14 | 18 | 18 | 36 |
| 5 | 4 | 4 | 2 | 36 | 36 | 38 | 2 | 4 |
| 6 | 3 | 3 | 5 | 4 | 4 | 9 | 9 | 18 |
| 7 | 2 | 2 | 16 | 18 | 18 | 34 | 34 | 68 |
| 8 | 1 | 1 | 10 | 68 | 31 | 41 | 5 | 10 |
| 9 | C | 12 | 11 | 10 | 10 | 21 | 21 | 42 |
| 10 | B | 11 | 12 | 42 | 5 | 17 | 17 | 34 |
| 11 | A | 10 | 1 | 34 | 34 | 35 | 35 | 70 |
| 12 | G | 16 | 2 | 70 | 33 | 35 | 35 | 70 |
| 13 | 5 | 5 | 3 | 70 | 33 | 36 | 36 | 72 |
| 14 | 2 | 2 | 4 | 72 | 35 | 39 | 3 | 6 |
| 15 | 4 | 4 | 0 | 6 | 6 | 6 | 6 | 12 |
| 16 | 2 | 2 | 0 | 12 | 12 | 12 | 12 | 24 |
| 17 | 1 | 1 | 2 | 24 | 24 | 26 | 26 | 52 |
| 18 | A | 10 | — | 52 | 15 | — | — | — |

S₁₈ is defined as S₁₈=P₁₈|₃₇+a₁, where a₁ is the check character. Therefore, since the condition is that S₁₈∥₃₆=1, a₁ should be calculated such that P₁₈|₃₇+a₁−1 is divisible by 36 without remainder. In the above example, where P₁₈|₃₇=15, the condition is that 15+a₁−1 is divisible by 36. Therefore, using the equation:

(15+a₁−1)/36=1

a₁ is found to equal 22, for the above example. According to Table 1, the number 22 represents the character “M”. Hence, the complete release ID is A1-2425G-ABC1234-002-M, as is shown in FIG. 9. Other optional method may be used to calculate or assign a check character to a release identifier and/or a license identifier.

C. Management of Release IDs and License IDs

An optional central registration service, which may include one or more central registration agencies, is responsible for providing national and regional support to users of the release and license metadata system. The central registration service allocates issuer codes for release IDs and/or license IDs to entities that satisfy criteria determined by the central registration service. The central registration service is also involved in the registration process of entities that intend to become issuers, including the management and quality assurance of collected metadata for releases and/or licenses.

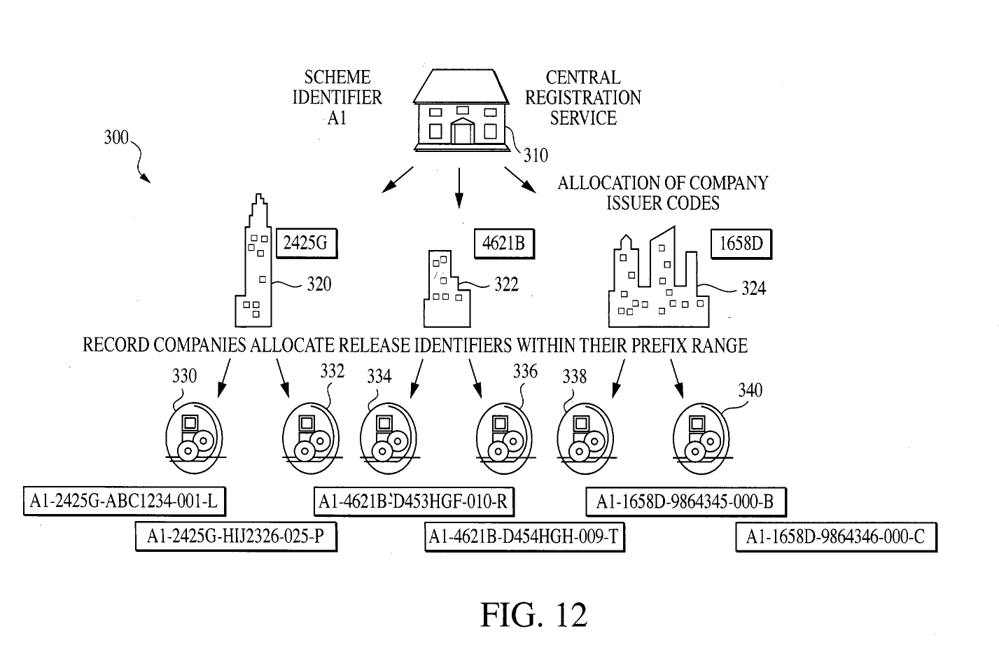

FIG. 12 illustrates a preferred method for assigning, for example, release ID issuer codes by the optional central registration service, denoted generally by reference numeral 300. Assignment method 300 may also be used for assigning license ID issuer codes. Central registration service 310 manages, for example, release IDs using the “A1” identifier scheme. Central registration service 310 allocates issuer codes “2425G,” “4621B,” and “1658D” to record companies 320, 322, and 324, respectively. Record companies 320, 322, and 324 then allocate release IDs, with the appropriate issuer code, to releases that are being issued, for example, to distributors and/or retailers. Record company 320, which is assigned issuer code “2425G,” issues two releases, 330 and 332, having release IDs “A1-2425G-ABC1234-001-L” and “A1-245G-HIJ2325-025-P,” respectively. Record company 322, which is assigned issuer code “4621B,” issues two releases, 334 and 336, having release IDs “A1-4621B-D453HGF-010-R” and “A1-4621B-D454HGH-009-T,” respectively. Finally, record company 324, which is assigned issuer code “1658D,” issues two releases, 338 and 340, having release IDs “A1-1658D-9864345-000-B” and “A1-1658D-9864346-000-C,” respectively.

II. Release and License Metadata

A standard metadata schema (Appendix A) preferably is used to describe the principle units of transaction for record companies and societies—namely releases or sound recordings and other assets, and license of musical works, respectively. Alternative entities may also utilize the release and/or license identifiers of the present invention. A standard metadata schema provides several advantages. The identification of and creation of standard data definition and their representations for data items that are common to both the record industry and to societies create a framework from which open information standards for the music industry can be established. The standard metadata schema provides a common means for the exchange of metadata.

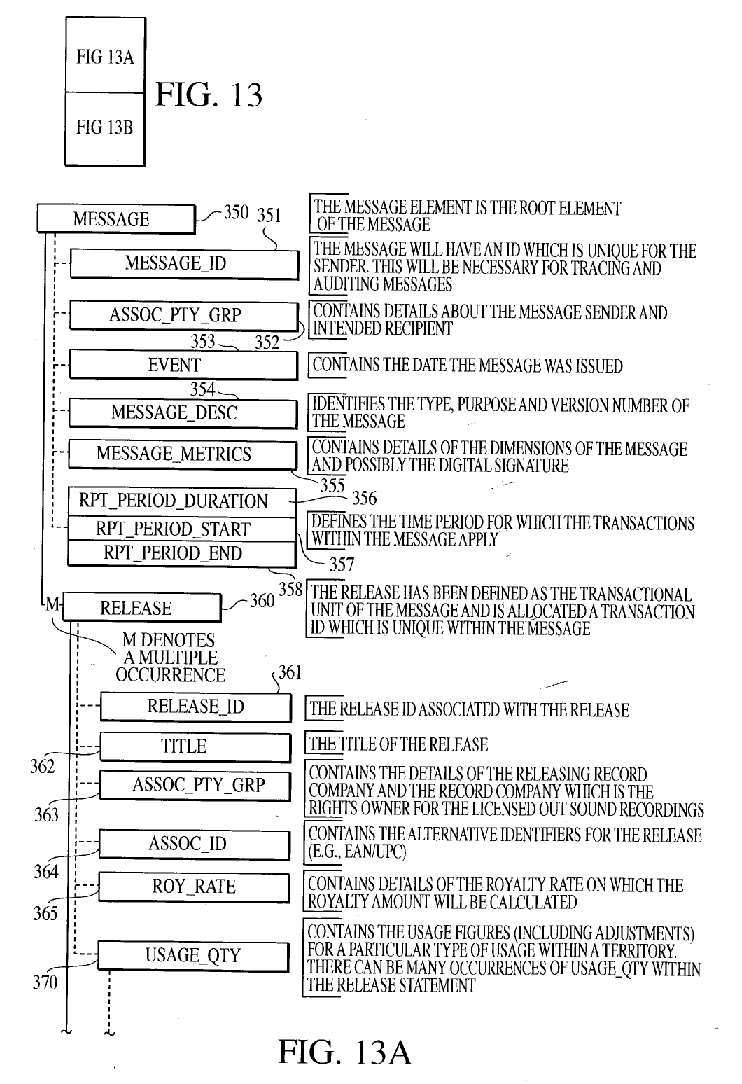

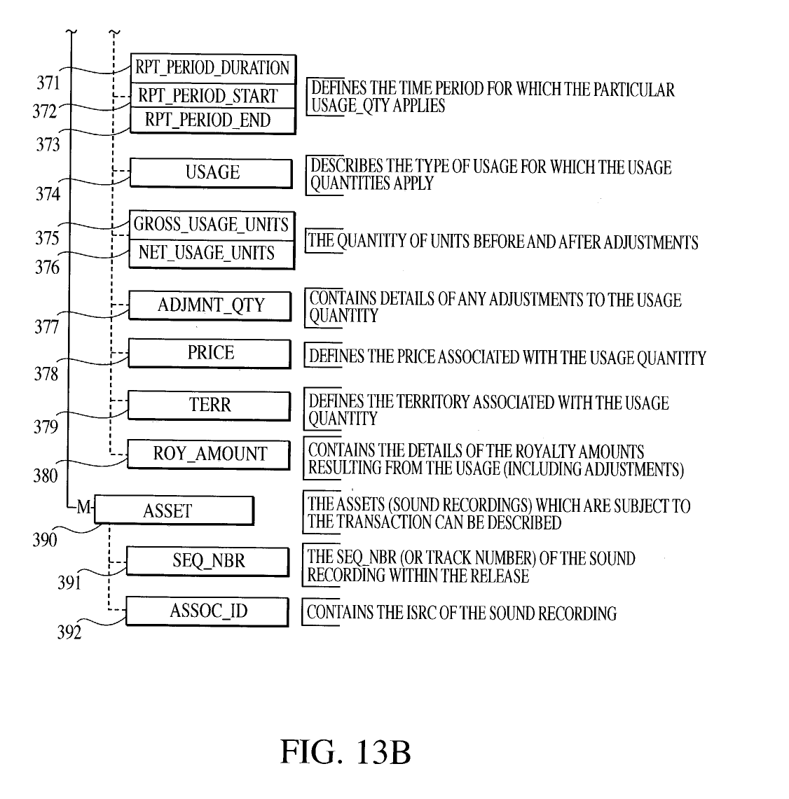

The standard metadata schema contains the terms and “allowed values” for the description of releases and/or licenses, as well as other units of transaction. The standard metadata schema also declares rules and defines the structures that are used to construct transaction messages. FIGS. 13, 14, 17, and 18 illustrate four examples of transaction messages that may be implemented using the standard metadata schema. Other formats and/or schemes may be used to describe the principle units of transaction.

FIGS. 13A and 13B illustrate an example of fields in a transaction message for an inter-company sales reporting transaction between two record companies. Message 350 supports, for example, third quarter sales and royalty reporting between Record Company A and Record Company B. The transaction message contains a group of descriptive fields that contain information regarding the subject(s) of the transaction message. MESSAGE_ID 351 is an identifier that is unique, for example, to the sender of message 350. ASSOC_PTY_GRP 352 contains details regarding, for example, the message sender and the intended recipient. EVENT 353 contains, for example, the data the message was issued. MESSAGE_DESC 354 identifies, for example, the type, purpose, and/or version number of the message. MESSAGE_METRICS 355 contains details regarding, for example, the dimensions of the message and possibly a digital signature. RPT_PERIOD_DURATION 356, RPT _PERIOD_START 357, and RPT_PERIOD_END 358 define, for example, the time period for which the transactions within the message apply.

In this example, message 350 contains sales figures for two releases contained within the message. Release(s) 360 may be a multiply occurring field, as denoted by the “M,” the fields of which contain information for each of the two releases, Release-1 and Release-2. Each release 360 is defined as the transactional unit of message 350 and is allocated a transaction ID, which is unique within message 350. In this example, Release-1 is a physical product, e.g., a compact disc (“CD”). Release-1 has a unique RELEASE_ID 361, as described above. TITLE 362 indicates the title of Release-1. Release-1 is distributed by Record Company A, as denoted by ASSOC_PTY_GRP 363, which contains the details of the release record company and the record company that owns the rights for the licenses sound recordings contained within Release-1. In this example Record Company B owns 13% of the phonographic rights of the sound recording featured in Release-1. Release-1 may also be identified with alternative identifiers (e.g., EAN/UPC), as denoted in ASSOC_ID 364. ROY_RATE 365 denotes the royalty rate that is used to calculate the royalties due to Record Company B.

USAGE_QTY 370, which also may be a multiply occurring field, contains, for example, the usage figures (including adjustments) for a particular type of usage within a territory. Within the field USAGE_QTY 370, numerous sub-fields may be used to provide additional information. RPT_PERIOD_DURATION 371, RPT_PERIOD_START 372, and RPT_PERIOD_END 373 define, for example, the time period for which the particular USAGE_QTY 370 applies. USAGE 374 describes the type of usage for which the usage quantities apply. GROSS_USAGE_UNITS 375 and NET_USAGE_UNITS 376 denote, for example, the quantity of usage units before and after adjustments. ADJMNT_QTY 377 contains details of any adjustments to the usage quantity. PRICE 378 defines the price associated with the usage quantity. TERR 379 defines the territory associated with the usage quantity, for example, the United States or Great Britain. ROY_AMOUNT 380 contains details of the royalty amounts resulting from the usage (including adjustments).

Asset(s) 390 denote the asset(s) (e.g., sound recording) contained within release(s) 360 that is subject to the transaction. As there may be multiple assets within a release, RELEASE 390 may be a multiply occurring field. SEQ_NBR 391 denotes, for example, the sequence number of the asset within the release, i.e., the track number on the CD. ASSOC_ID 392 contains, for example, the ISRC of the sound recording that makes up asset 390. Each field described above may contain multiple sub_fields to allow for more detailed information within the transaction message. The information associated with Release-2 is presented in message 350 using parallel fields under release 360.

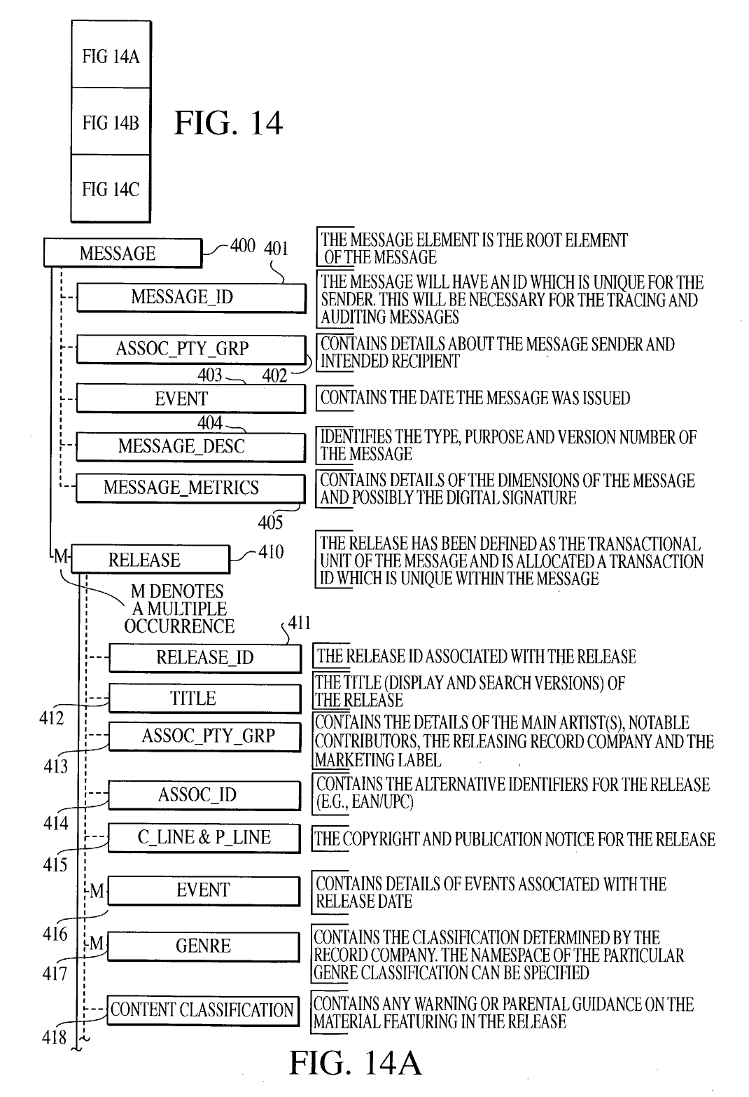

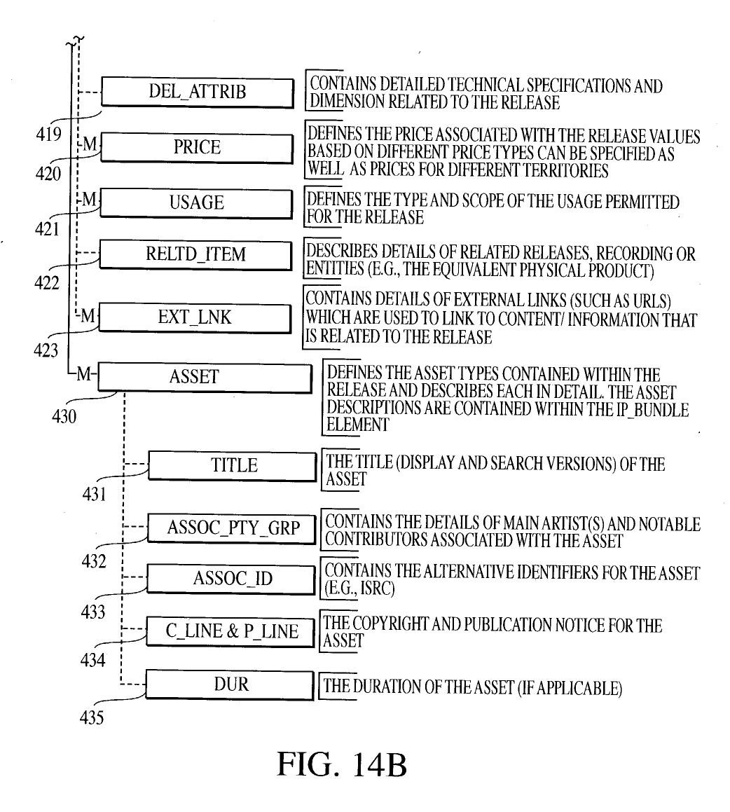

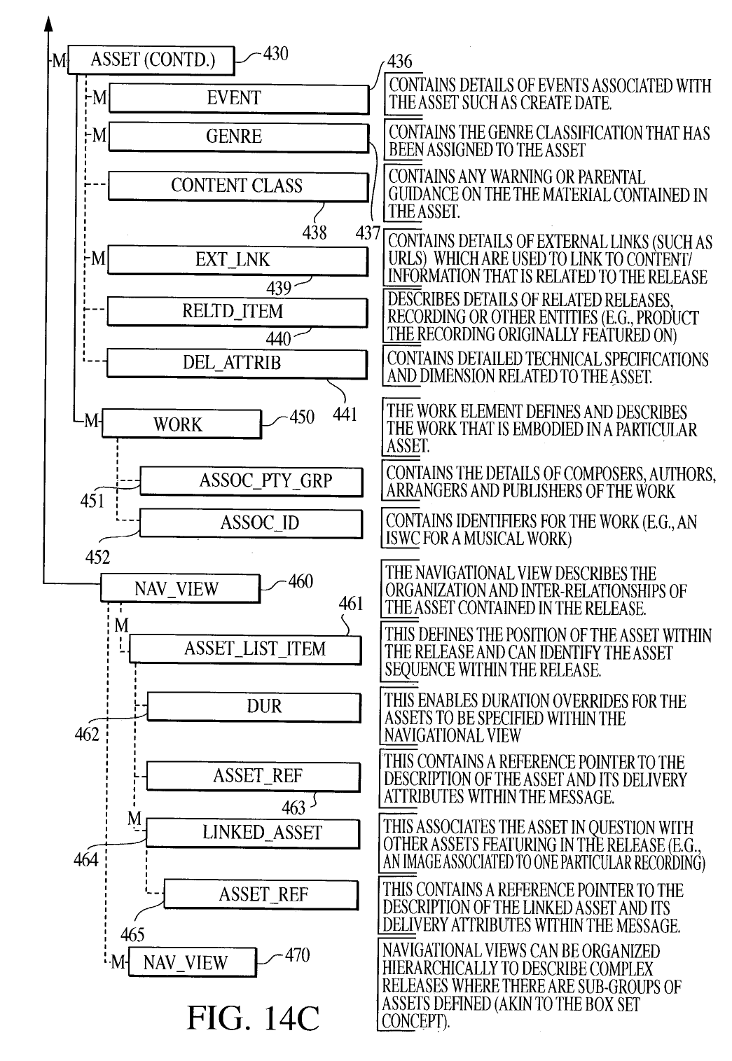

FIGS. 14A, 14B, and 14C illustrate an example of fields in a transaction message for a retail notification transaction between a record company to a retailer or an affiliate. In FIG. 14A, message 400 supports, for example, details sent from Record Company to Retailer regarding two releases: a complex multimedia product and a simple single track product. Message 400 contains a group of descriptive fields similar to the descriptive fields described with regard to message 350: MESSAGE_ID 401; ASSOC_PTY_GRP 402; EVENT 403; MESSAGE_DESC 404; and MESSAGE_METRICS 405.

In this example, message 400 contains details about two releases, Release-1 and Release-2, which are both on-line products. Release-1, a download product, contains several assets and Release-2, a streaming product, contains a single asset. Both Release-1 and Release-2 contain a navigational viewing feature.

Release(s) 410, may be a multiply occurring field, as denoted by the “M,” and contains information for each of the two releases, Release-1 and Release-2. As in the previous example, each release 410 is allocated a transaction ID. Each release 410 also has a unique RELEASE_ID 411 and TITLE 412. ASSOC_PTY_GRP 413 contains details regarding, for example, the main artist(s), notable contributors, the releasing record company, the marketing label, etc. C_LINE & P_LINE 415 contains the copyright and/or publication notice for release 410. EVENT 416 contains details of events associated with release 410, such as a release date.

GENRE 417 contains, for example, the classification determined by the record company, i.e. R&B, hip-hop, pop, and/or country & western. CONTENT CLASSIFICATION 418 contains, for example, any warning or parental guidance information on the material featured in release 410. DEL_ATTRIB 419 contains, for example, detailed technical specifications and dimensions related to release 410, such as the operating system on which release 410 can be downloaded.

PRICE 420 defines, for example, the price associated with release 410. Values based on different price types can be specified, e.g., US dollars or British pounds, as well as prices for different territories. As in the previous example, USAGE 421 defines the type and scope of the usage permitted for release 410. RELTD_ITEM 422 describes, for example, details of related releases, recordings, and/or entities (e.g., the equivalent physical product to the on-line release). EXT_LNK 423 contains, for example, details of external links (e.g. URLs), which are used to link to content and/or information that is related to release 410.

In this example, Release-1 contains a plurality of different assets: audio assets (e.g., the sound recordings), image assets (e.g., cover artwork and photographs), text assets (e.g., lyrics), software assets (e.g., a screensaver), and video assets (e.g., a music video). Information for each asset is contained in the multiply occurring field Asset 430 and its sub-fields. Asset 430 defines, for example, the asset types contained within release 410 and describes each in detail. The asset descriptions are associated with the IP bundle for the release.

TITLE 431 contains the title of asset 430, for example, in display and search versions. ASSOC_PTY_GRP 432 contains, for example, details of main artist(s) and notable contributors associated with asset 430. ASSOC_ID 433 contains, for example, alternative identifiers for asset 430 (e.g., ISRC). C_LINE & P_LINE 434 contains the copyright and/or publication notice for asset 430, as compared to C_LINE & P_LINE 415, which contains notice(s) for the entire release 410. DUR 435 denotes, for example, the duration of asset 430, such as playing time, if applicable.

Continuing in FIG. 14B, EVENT 436 contains, for example, details of events associated with asset 430, such as a creation date. GENRE 437 denotes genre classification information for asset 430, which may differ from GENRE 417 for the entire release. Likewise, CONTENT CLASS 438 contains, for example, any additional warnings or parental guidance information for the release apart from CONTENT CLASSIFICATION 418 for the entire release. EXT_LNK 439 contains, for example, details of external links used to link to content and/or information related to asset 430. RELTD_ITEM 440 describes, for example, details of related releases, recordings, etc., such as the release on which the asset originally featured. DEL_ATTRIB 441 contains, for example, detailed technical specifications and dimensions related to asset 430.

Each asset 430 may additionally contain information regarding the work present in that asset. Work(s) 450 defines and describes the work that is embodied in a particular asset 430. ASSOC_PTY_GRP 451 contains, for example, the details of composers, authors, arrangers, and/or publishers of work 450. ASSOC_ID 452 contains, for example, identifiers for work 450 (e.g., an ISWC for a musical work). By associating asset and work information, license information for works in an asset optionally can be related to a release.

Releases 400 also have an optional navigational view feature, NAV_VIEW 460. NAV_VIEW 460 provides a visual description of the organization and inter-relationships for asset(s) 430 contained in release(s) 400. ASSET_LIST_ITEM 461 defines, for example, the position of asset 430 within release 410 and identifies the asset sequence within release 410. There may be an ASSET_LIST_ITEM 461 associated with each asset 430 within release 410. DUR 462 enables duration overrides for asset 430 to be specified within NAV_VIEW 460, for example, if a user wishes to play only a portion rather than an entire track.

ASSET_REF 463 contains, for example, a reference pointer to the description of asset 430 and its delivery attributes within message 400. LNKD_ASSET 464 associates asset 430 with other assets featured in release 410 (e.g., an image associated to one particular recording). ASSET_REF 465 contains, for example, a reference pointer to the description of the linked asset 430 and its delivery attributes within message 400.

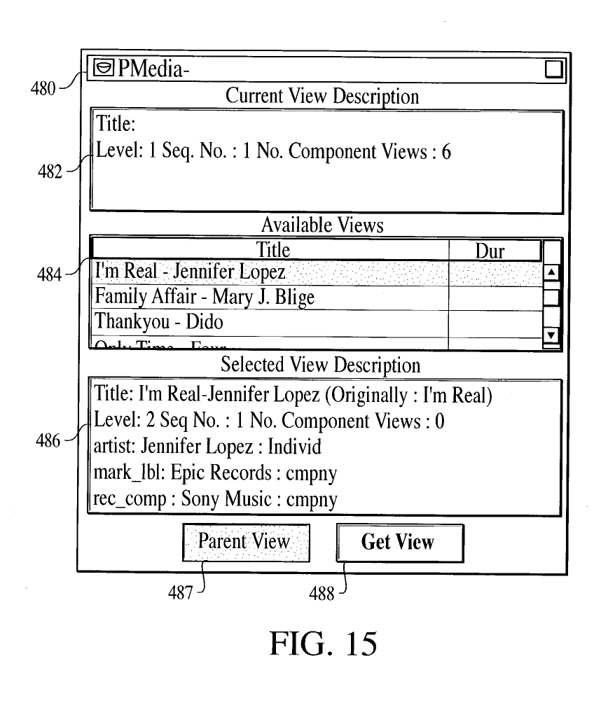

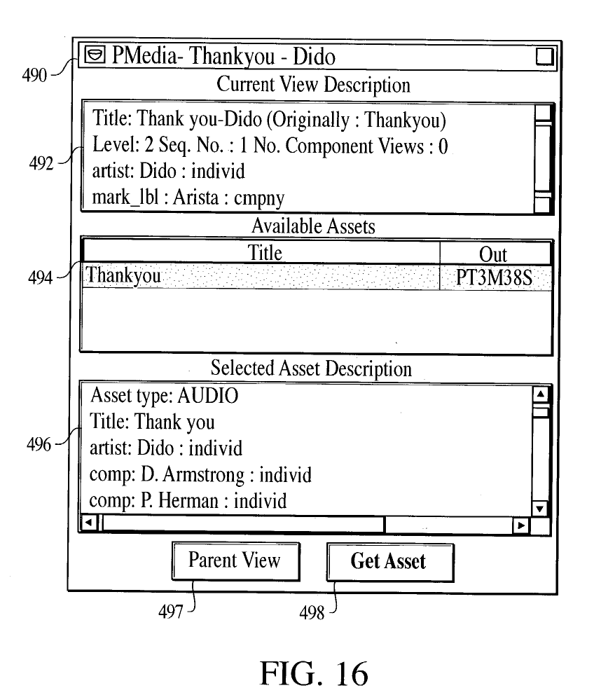

Additional optional navigational views may exist within a navigational view, as shown by NAV_VIEW 470. Navigational views can be organized hierarchically to describe complex releases where there are sub-groups of assets defined (e.g., in a CD box set). FIGS. 15 and 16 illustrate examples of navigational views for a release.

In FIG. 15, navigational view dialogue box 480 has title bar 482, which contains the display title for the navigational view currently being viewed. Available views table 484 shows assets and/or views, available as child views (e.g., NAV_VIEW 470) of the current view (e.g., NAV_VIEW 460). Selected view description bar 486 displays details for the currently selected asset and/or view in Available view table 484. If the view currently being displayed is the child of another view, parent view button 487 allows the user to access the parent navigational view. If the current navigational view does not have a parent, parent view button 487 is disabled. Get view button 488 changes the navigational view displayed to the currently selected navigational view. If assets are being displayed, the button text preferably will read “Get Asset” and the button will initiate download and playback of the currently selected asset.

In FIG. 16, navigational view dialogue box 490 shows only assets. Navigational view dialogue box 490 functions similarly to navigational view dialogue box 480. Title bar 492 displays details associated with the currently selected view. Available assets list 494 displays the assets that are accessible through the current view. Selected asset description bar 496 displays the details of the currently selected asset. Navigational view dialogue box 490 also has parent view button 497 and get asset button 498.

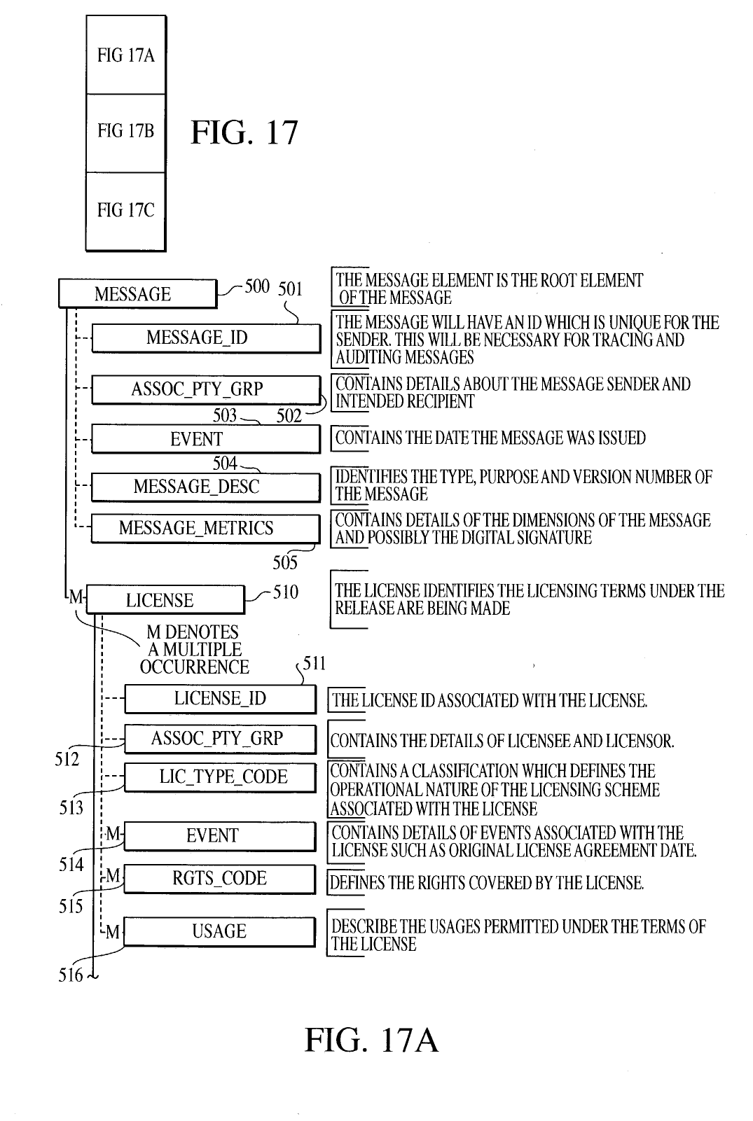

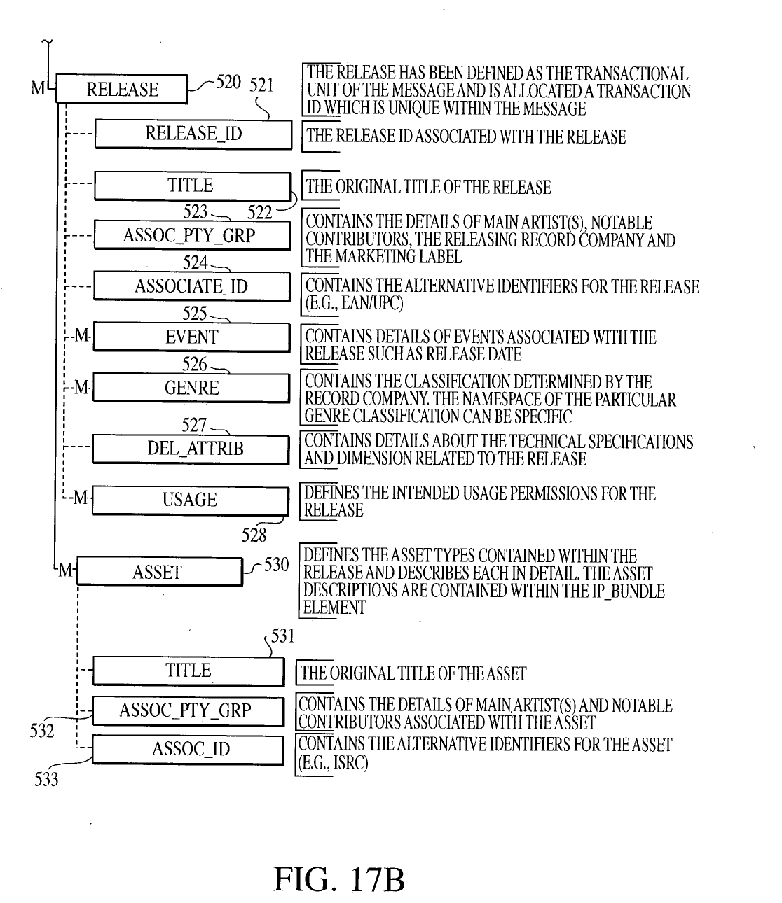

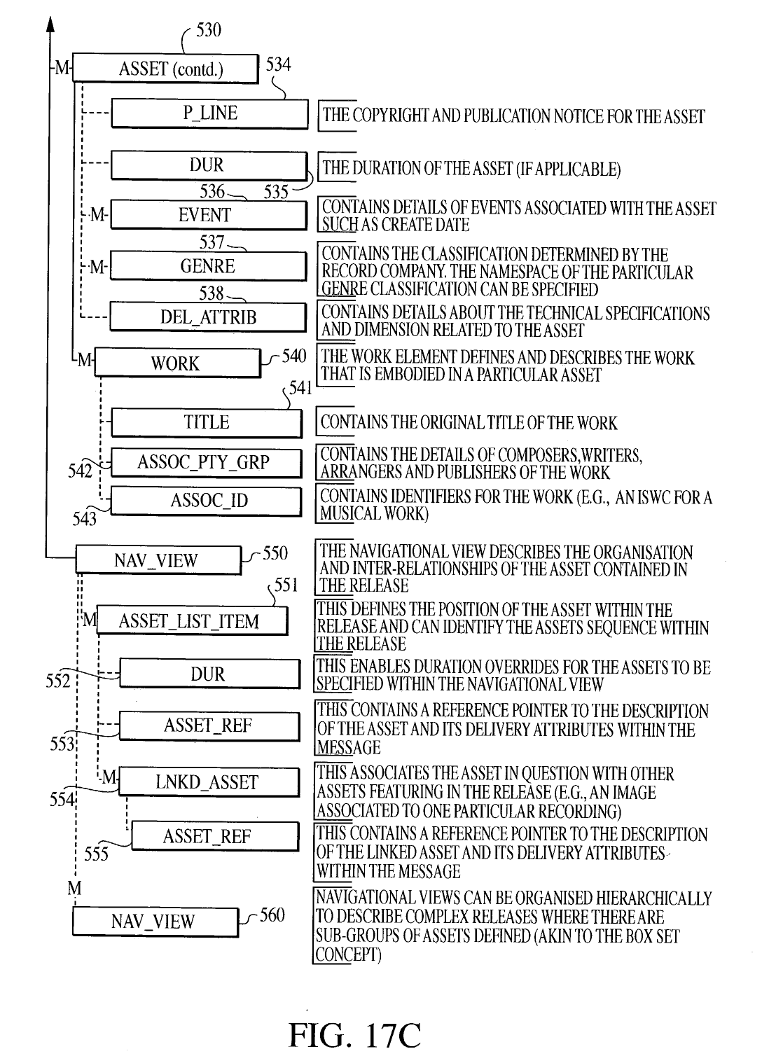

FIGS. 17A, 17B, and 17C illustrate an example of fields in a transaction message for a release notification licensing transaction between, for example, a record company and a society. As seen in FIG. 17A, message 500 supports, for example, the notification of a release from Record Company to a licensing Society under a pre-arranged licensing agreement. Message 500 contains details regarding a pre-defined licensing agreement and details regarding two releases: a multimedia product and a simple single-track product. The multimedia product contains, for example, two sound recording, each embodying one musical work, and two images. Message 500 contains a group of descriptive fields similar to the descriptive fields described with regard to message 350 and message 400: MESSAGE_ID 501; ASSOC_PTY_GRP 502; EVENT 503; MESSAGE_DESC 504; and MESSAGE_METRICS 505.

Licence 510, which optionally may be a multiply occurring field, identifies the licensing terms under which the release(s) is being made. License 510 has a unique LICENSE_ID 511, as described above. ASSOC_PTY_GRP 512 contains the details of the licensee and licensor, for example, the licensee Record Company and the licensor Society. LIC_TYPE_CODE 513 contains, for example, a classification, which defines the operational nature of the licensing scheme associated with the license. EVENT 525 contains details of events associate with license 510, for example, the original license agreement date. RGTS_CODE 515 defines, for example, the rights covered by the license, e.g., mechanical rights, synchronization rights, and/or performing rights. USAGE 516 describes the usages permitted under license 510.

The terms and conditions of license 510 cover release(s) 520. Release 520 contains information in sub-fields as described with respect to release(s) 410 (FIG. 14A). The information regarding release 520 includes, for example: RELEASE_ID 521; TITLE 522; ASSOC_PTY_GRP 523; ASSOC_ID 524; EVENT 525; GENRE 526; DEL_ATTRIB 527; and USAGE 528.

The asset(s) contained within release(s) 520 are described in the field asset 530 and its sub-fields, as seen in FIGS. 17A-17C. As described with respect to asset(s) 430 (FIGS. 14A-14C), the information regarding asset(s) 530 include, for example: TITLE 531; ASSOC_PTY_GRP 532; ASSOC_ID 533; C_LINE & P_LINE 534; DUR 535; EVENT 536; GENRE 537; and DEL_ATTRIB 538.

The works included in each asset 530, for example, the musical works embodied in each sound recording, are described in field work(s) 540. TITLE 541 denotes the original title of the work. ASSOC_PTY_GRP 542 contains the details of, for example, the composers, writers, arrangers, and publishers of work 540. ASSOC_ID contains, for example, identifiers for work 540 (e.g., ISWC for a musical work).

NAV_VIEW 550 describes the organization and inter-relationships of asset(s) 530 contained within release(s) 520. As described with respect to NAV_VIEW 460 (FIG. 14B), information regarding the navigational viewing feature includes, for example: ASSET_LIST_ITEM 551; DUR 552; ASSET_REF 553; LNK_ASSET 554; and ASSET_REF 555. NAV_VIEW 560 may also include subordinate navigational views, NAV_VIEW 560.

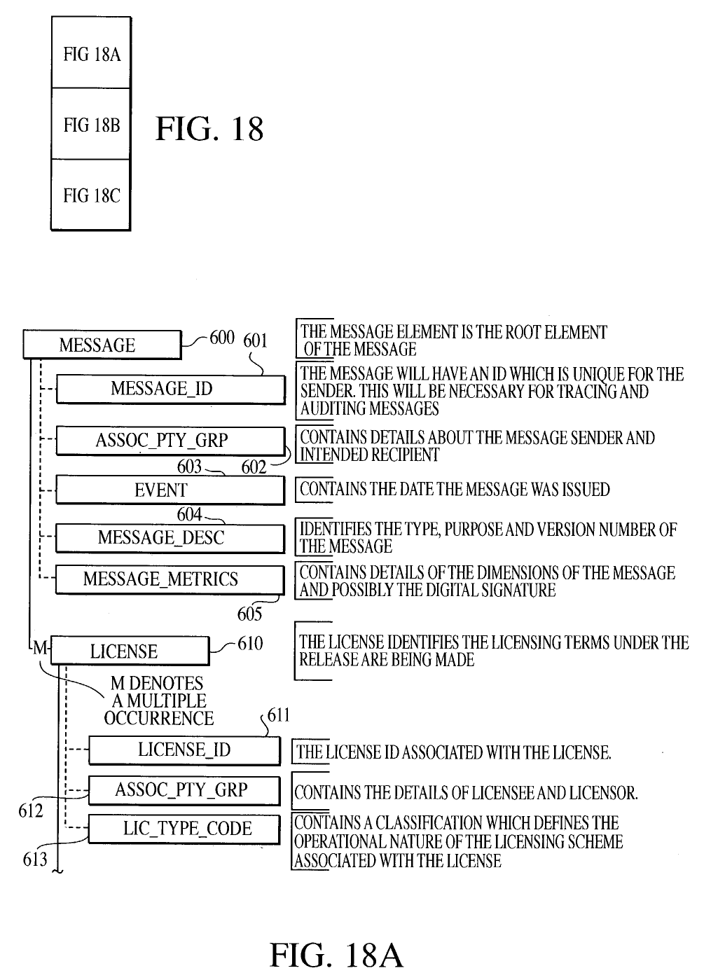

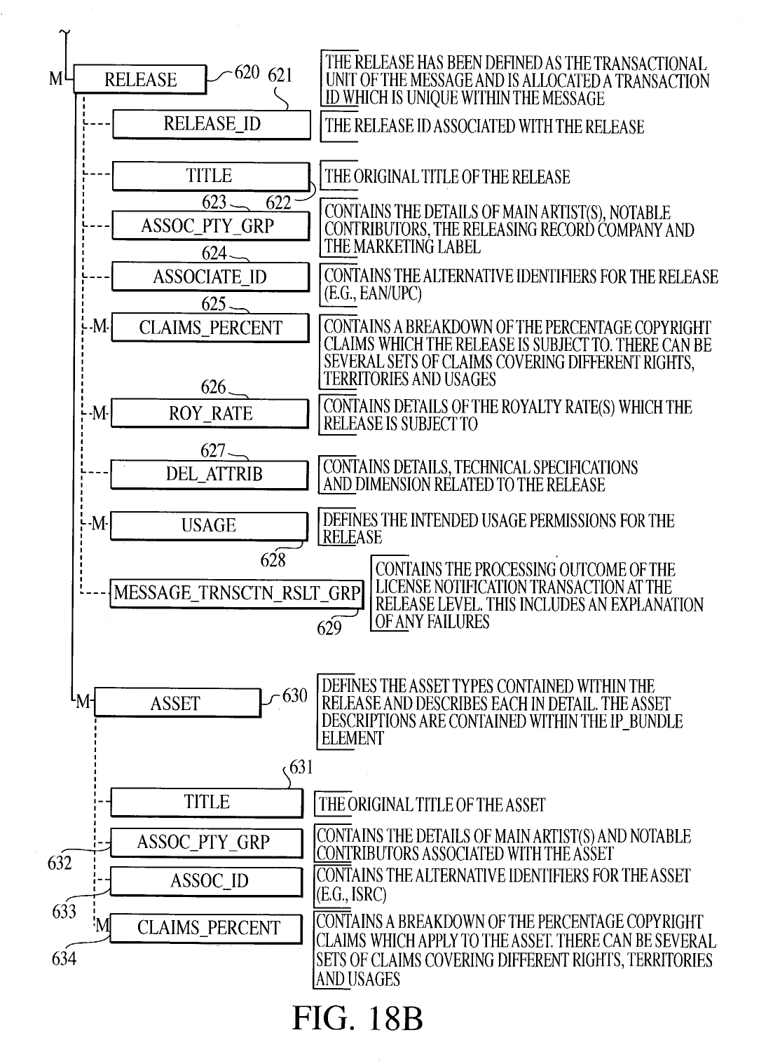

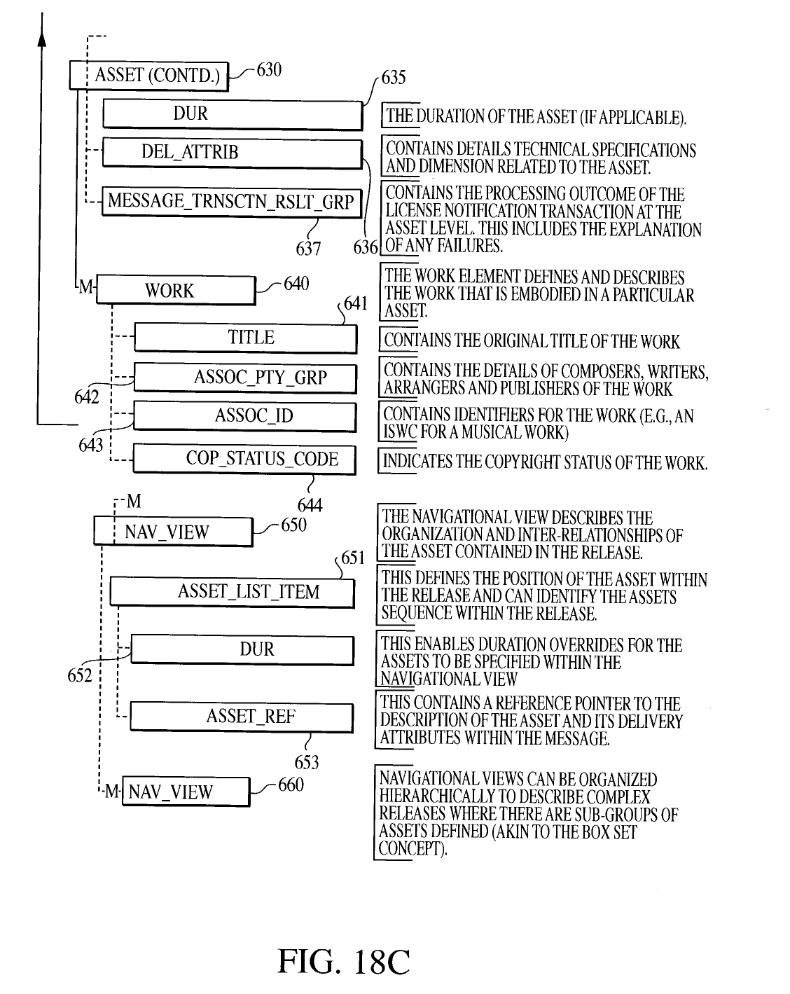

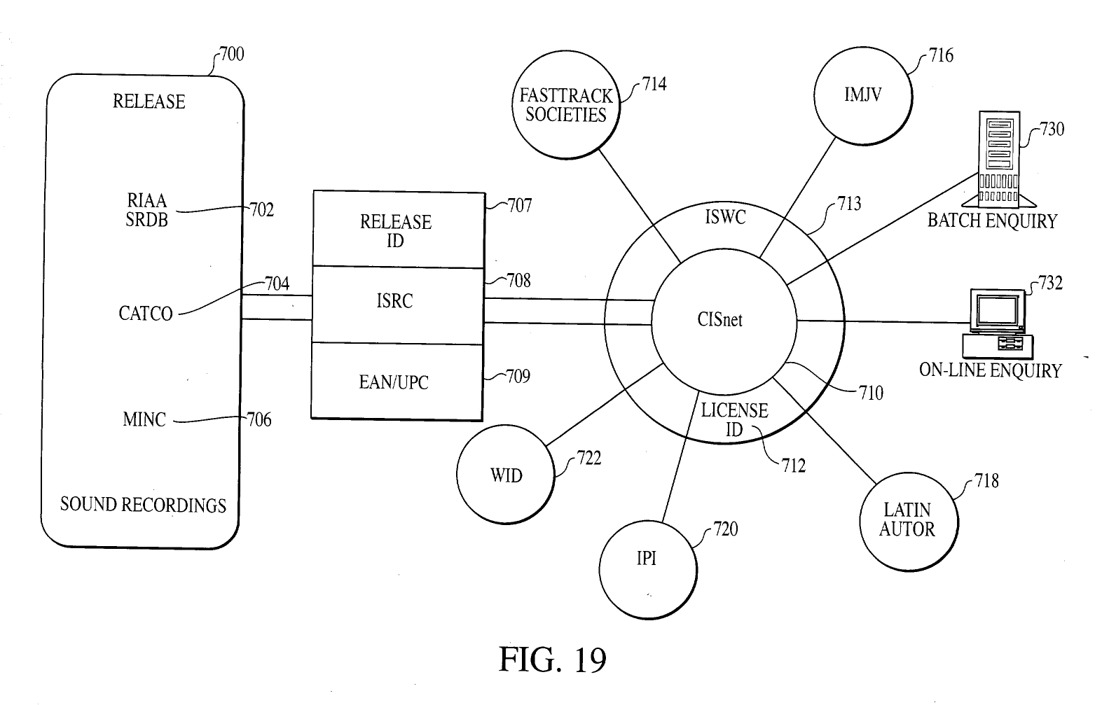

FIGS. 18A, 18B, and 18C illustrate an example of fields in a transaction message for a release confirmation licensing transaction from a society to a record company. As seen in FIG. 18A, message 600 supports, for example, the confirmation of the licensing information for a release. Message 600 is sent by a Society to a Record Company and the confirmation is made under the terms of a pre-arranged licensing agreement. Message 600 identifies, for example, a pre-defined licensing agreement and the licensing details regarding two releases: a multimedia product, which contains two sound recording, each embodying one musical work, and two images; and a simple single-track product. Message 600 contains a group of descriptive fields similar to the descriptive fields described with regard to message 350, message 400, and message 500: MESSAGE_ID 601; ASSOC_PTY_GRP 602; EVENT 603; MESSAGE_DESC 604; and MESSAGE_METRICS 605.

License 610, which may be a multiply occurring field, identifies the licensing terms under which the release(s) is being made. As described with respect to license 510 (FIG. 17A), the information that describes license 610 includes, for example: LICENSE_ID 611; ASSOC_PTY_GRP 612; and LIC_TYPE_CODE 513.

The terms and conditions of license 610 cover release(s) 620. Release 620 contains information in sub-fields as described with respect to release(s) 410 (FIG. 14A) and release(s) 510 (FIG. 17A). The information regarding release 620 includes, for example: RELEASE_ID 621; TITLE 622; ASSOC_PTY_GRP 623; ASSOC_ID 624; DEL_ATTRIB 627; and USAGE 628. In this example, release 620 also includes CLAIMS_PERCENT 625, which contains, for example, a breakdown of the percentage copyright claims to which release 620 is subject. There may be several sets of claims covering different right, territories, and usages. ROY_RATE 626 contains details of the royalty rate(s) to which release 620 is subject. MESSAGE_TRNSCTN_RSLT_GRP 629 contains, for example, the processing outcome for the license notification transaction at the release level, including an explanation of any failures.

The asset(s) contained within release(s) 620 are described in the field asset 630 and its sub-fields, as seen in FIGS. 18A-18C. As described with respect to asset(s) 430 (FIGS. 14A-14C) and asset(s) 530 (FIGS. 17A-17C), the information regarding asset(s) 630 include, for example: TITLE 631; ASSOC_PTY_GRP 632; ASSOC_ID 633; DUR 635; and DEL_ATTRIB 636. In this example, asset 630 also includes CLAIMS_PERCENT 634, which contains, for example, a breakdown of the percentage copyright claims, which apply to asset 630. There may be several sets of claims covering different rights, territories, and usages. MESSAGE_TRNSCTN_RSLT_GRP 637 contains, for example, the processing outcome of the license notification transaction at the asset level, including the explanation for any failures.

Work(s) 640 defines and describes the work(s) that is embodied in a particular asset 630. As with respect to work 530 (FIG. 17B), work 640 contains information including, for example: TITLE 641; ASSOC_PTY_GRP 642; and ASSOC_ID 643. In this example, work 640 also includes COP_STATUS_CODE 644, which indicates the copyright status of work 640.

NAV_VIEW 650 describes the organization and inter-relationships of asset(s) 630 contained within release(s) 620. As described with respect to NAV_VIEW 460 (FIG. 14B) and NAV_VIEW 550 (FIG. 17B), information regarding the navigational viewing feature includes, for example: ASSET_LIST_ITEM 651; DUR 652; and ASSET_REF 653. NAV_VIEW 650 may also include subordinate navigational views, NAV_VIEW 660.

III. Information Architecture

FIG. 19 is a diagram of an information architecture to support access to release and license metadata, in accordance with one embodiment of the invention when the data comprises musical works associated with the Recording Industry. Entities responsible for releases, such as record companies, preferably maintain repositories 700 for release metadata. For example, RIAA/SRDB 702 maintains repositories in the US, CatCo 704 maintains repositories in the United Kingdom, and MINC 706 maintains repositories in Japan.

Entities responsible for licensing, such as societies, preferably maintain a distributed network, for example, CISnet 710, to provide access to information regarding musical works. Societies responsible for licensing and maintaining CISnet 710 include, for example: FastTrack 714; International Music Joint Venture (“IMJV”) 716; Latin Autor 718; Interest Party Identifier (“IPI”) 720; and WID 722. In another embodiment, an extension to CISnet 710 is used to provide a repository for license information regarding those musical works.

Access to release information in repositories 700, may be accessed using release ID 707, as described above, or through some alternate means of identification, for example, ISRC 708, and/or EAN/UPC 709. Access to license information through CISnet 710 and/or some additional repository, may be accessed using license ID 712, as described above, or through some alternate means of identification, for example, ISWC 713.

Access to release information stored in repositories 700 may be achieved through CISnet 710 using a batch enquiry 730 and/or an on-line enquiry 732. Alternatively, access to release information may be achieved by accessing repositories 700 directly. Access to license information through CISnet 710 may also be achieved using a batch enquiry 730 and/or an on-line enquiry 732. If license information is being stored in some additional repository, access may be achieved through CISnet 710, or alternatively to the additional repository directly.

The open network architecture of CISnet 710 allows for repositories 700, for example, to become additional “nodes,” and therefore, to provide societies access to information about releases and/or sound recordings. Similarly, CISnet 710 provides the means for record companies to access metadata regarding musical works.

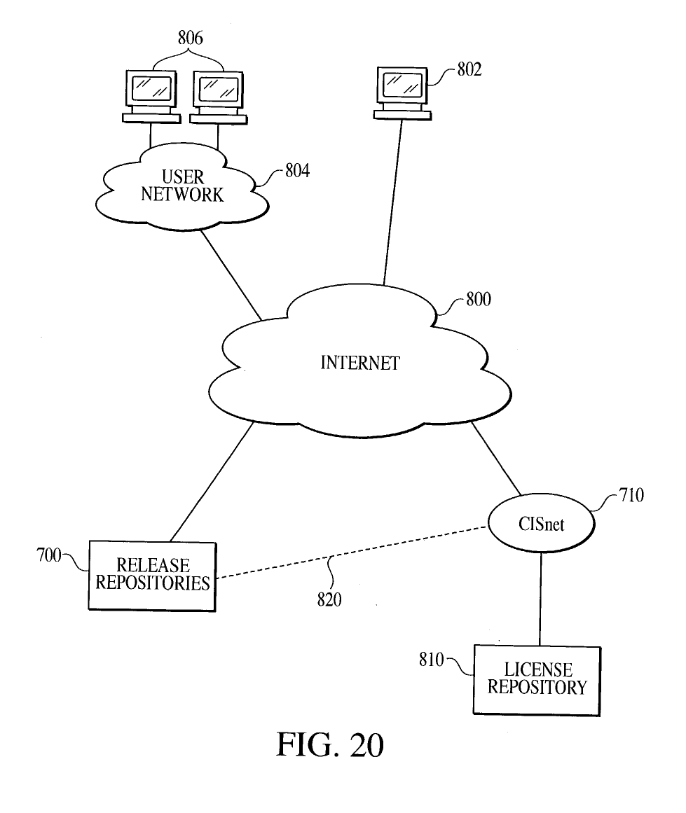

FIG. 20 is a diagram of an example of a communications network used to access release and/or license metadata, such as Internet 800. Users can access the data using a single user terminal 802, e.g., a customer downloading a electronic music file to a home computer. Alternately, a user in a network environment can access the data using user network 804 and networked user terminal 806, e.g., in a local area network environment.

As described above, release data resides in repositories 700 and license data can be accessed using CISnet 710. The actual license metadata may reside in some repository, for example, license repository 810. In one embodiment, release data can be accessed directly from repositories 700. In another embodiment, release data can be access through CISnet 710 over link 820.

The many features and advantages of the invention are apparent from the detailed specification, and thus, it is intended by the appended claims to cover all such features and advantages of the invention, which fall within the true spirit and scope of the invention. Further, since numerous modifications and variations will readily occur to those skilled in the art, it is not desired to limit the invention to the exact construction illustrated and described, and accordingly, all suitable modifications and equivalence may be resorted to, falling within the scope of the invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A memory storing a data structure that comprises release identifier information relating to at least one of identification, validation, authorization, and use of data comprising at least one of a data arrangement, a data collection, and a data set, and at least one intellectual property right associated with the data, the data structure being retrieved from the memory responsive to instructions being implemented by at least one of a data processor and a computer, the data structure comprising:
a first data element comprising an issuer code;
a second data element comprising an intellectual property bundle number; and
a third data element comprising a check character, wherein the first, second, and third data elements are used in the at least one of the identification, validation, authorization, and use of the data.

2. The memory of claim 1, wherein the issuer code uniquely identifies an entity responsible for issuing a release identifier.

3. The memory of claim 1, wherein the intellectual property bundle number is allocated uniquely by an entity that has been assigned the issuer code to identify a collection of intellectual property assets and accompanying metadata associated with a release.

4. The memory of claim 1, wherein the check character is used to facilitate correct entry of a release identifier into the memory.

5. The memory of claim 1, wherein the data structure further comprises a fourth data element comprising a delivery attribute extension.

6. The memory of claim 5, wherein the delivery attribute extension is allocated uniquely by an entity that has been assigned the issuer code to distinguish between different versions of a release.

7. The memory of claim 1, wherein the data structure further comprises a fifth data element comprising a release identifier scheme.

8. The memory of claim 7, wherein the release identifier scheme uniquely identifies an identification scheme for a release.

9. A memory storing a data structure that comprises license identifier information relating to at least one of identification, validation, authorization, and use of data comprising at least one of a data arrangement, a data collection, and a data set, and at least one intellectual property right associated with the data, the data structure being retrieved from the memory responsive to instructions being implemented by at least one of a data processor and a computer, the data structure comprising:
a first data element comprising an issuer code;
a second data element comprising a license reference; and
a third data element comprising a check character, wherein the first, second, and third data elements are used in the at least one of the identification, validation, authorization, and use of the data.

10. The memory of claim 9, wherein the issuer code uniquely identifies an entity responsible for issuing a license identifier.

11. The memory of claim 9, wherein the license reference is allocated uniquely by an entity that has been assigned the issuer code to identify a license and accompanying metadata associated with the license.

12. The memory of claim 9, wherein the check character is used to facilitate correct entry of a release identifier into the memory.

13. The memory of claim 9, wherein the data structure further comprises a fourth data element comprising a society auxiliary extension.

14. The memory of claim 13, wherein the society auxiliary extension is allocated uniquely by an entity that has been assigned the issuer code to distinguish between difference versions of a license.

15. The memory of claim 9, the data structure further comprising a fifth data element comprising an identifier scheme.

16. The memory of claim 15, wherein the identifier scheme uniquely identifies an identification scheme for a license.

17. A memory storing a data structure that comprises release identifier information relating to at least one of identification, validation, authorization, and use of data comprising at least one of a data arrangement, a data collection, and a data set, and at least one intellectual property right associated with the data, the data structure being retrieved from the memory responsive to instructions being implemented by at least one of a data processor and a computer, the data structure comprising:
a first data element comprising an identifier scheme, the identifier scheme comprising two valid characters;
a second data element comprising an issuer code, the issuer code comprising five valid characters, wherein the first data element precedes the second data element;
a third data element comprising an intellectual property bundle number, the intellectual property bundle comprising ten valid characters, wherein the second data element precedes the third data element, wherein a valid character is one of any upper case letter of the Roman alphabet, excluding “I” and “O”, and any Arabic digit, and wherein the valid character is defined using ASCII codes; and
a fourth data element comprising a check character, the check character comprising one character comprising one of any upper case letter of the Roman alphabet and any Arabic digit, wherein the character is defined using ASCII codes, and wherein the third data element precedes the fourth data element.

18. The memory of claim 17, wherein the first, second, third, and fourth data elements are separated by a hyphen.

19. A memory storing a data structure that comprises release identifier information relating to at least one of identification, validation, authorization, and use of data comprising at least one of a data arrangement, a data collection, and a data set, and at least one intellectual property right associated with the data, the data structure being retrieved from the memory responsive to instructions being implemented by at least one of a data processor and a computer, the data structure comprising:
a first data element comprising an identifier scheme, the identifier scheme comprising two valid characters;
a second data element comprising an issuer code, the issuer code comprising five valid characters, wherein the first data element precedes the second data element;
a third data element comprising an intellectual property bundle number, the intellectual property bundle comprising seven valid characters, wherein the second data element precedes the third data element;
a fourth data element comprising a delivery attribute extension, the delivery attribute extension comprising three valid characters, wherein the third data element precedes the fourth data element, wherein a valid character is one of any upper case letter of the Roman alphabet, excluding “I” and “O”, and any Arabic digit, and wherein the valid character is defined using ASCII codes; and
a fifth data element comprising a check character, the check character comprising one character comprising one of any upper case letter of the Roman alphabet and any Arabic digit, wherein the character is defined using ASCII codes, and wherein the fourth data element precedes the fifth data element.

20. The memory of claim 19, wherein the first, second, third, fourth, and fifth data elements are separated by a hyphen.

21. A memory storing a data structure that comprises license identifier information relating to at least one of identification, validation, authorization, and use of data comprising at least one of a data arrangement, a data collection, and a data set, and at least one intellectual property right associated with the data, the data structure being retrieved from the memory responsive to instructions being implemented by at least one of a data processor and a computer, the data structure comprising:
a first data element comprising an identifier scheme, the identifier scheme comprising two valid characters;
a second data element comprising an issuer code, the issuer code comprising five valid characters, wherein the first data element precedes the second data element;
a third data element comprising a license reference, the license reference comprising ten valid characters, wherein the second data element precedes the third data element, wherein the third data element precedes the fourth data element, wherein a valid character is one of any upper case letter of the Roman alphabet, excluding “I” and “O”, and any Arabic digit, and wherein the valid character is defined using ASCII codes; and
a fourth data element comprising a check character, the check character comprising one character comprising one of any upper case letter of the Roman alphabet and any Arabic digit, wherein the character is defined using ASCII codes, and wherein the third data element precedes the fourth data element.

22. The memory of claim 25, wherein the first, second, third, and fourth data elements are separated by a hyphen.

23. A memory storing a data structure that comprises license identifier information relating to at least one of identification, validation, authorization, and use of data comprising at least one of a data arrangement, a data collection, and a data set, and at least one intellectual property right associated with the data, the data structure being retrieved from the memory responsive to instructions being implemented by at least one of a data processor and a computer, the data structure comprising:
a first data element comprising an identifier scheme, the identifier scheme comprising two valid characters;
a second data element comprising an issuer code, the issuer code comprising five valid characters, wherein the first data element precedes the second data element;
a third data element comprising a license reference, the license reference comprising seven valid characters, wherein the second data element precedes the third data element;
a fourth data element comprising a society auxiliary extension, the society auxiliary extension comprising three valid characters, wherein the third data element precedes the fourth data element, wherein a valid character is one of any upper case letter of the Roman alphabet, excluding “I” and “O”, and any Arabic digit, and wherein the valid character is defined using ASCII codes; and
a fifth data element comprising a check character, the check character comprising one character comprising one of any upper case letter of the Roman alphabet and any Arabic digit, wherein the character is defined using ASCII codes, and wherein the fourth data element precedes the fifth data element.

24. The memory of claim 23, wherein the first, second, third, fourth, and fifth data elements are separated by a hyphen.

25. A method of managing identification and description of at least one release, comprising:
determining the contents of the at least one release;
obtaining at least one release identifier associated with a unique one of the at least one release;
obtaining musical work details associated with the contents of the at least one release; and
compiling at least one label copy, wherein the at least one label copy comprises the contents of the at least one release, the at least one release identifier, and the musical work details.

26. The method of claim 25, wherein obtaining the at least one release identifier further comprises obtaining at least one issuer code, wherein the issue code is issued by a central registration service and is assigned to a unique one of at least one issuing entity, which issues the at least one release.

27. The method of claim 25, wherein obtaining the at least one release identifier further comprises obtaining at least one intellectual property bundle number, which is allocated uniquely by an entity that has been assigned an issuer code to identify a collection of intellectual property assets and accompanying metadata associated with the at least one release.

28. The method of claim 25, wherein obtaining the at least one release identifier further comprises calculating a check character.

29. The method of claim 25, wherein obtaining the at least one release identifier further comprises obtaining a delivery attribute extension, which is allocated uniquely by an entity that has been assigned an issuer code to distinguish between different versions of the at least one release.

30. The method of claim 25, wherein obtaining the at least one release identifier further comprises obtaining a release identifier scheme, which uniquely identifies an identification scheme for the at least one release.

31. A method of managing identification and description of at least one license associated with at least one release, comprising:
notifying at least one licensing entity of the at least one release;
determining the terms of the at least one license, wherein the terms are negotiated between the at least one licensing entity and at least one issuer entity that issues the at least one release; and
generating at least one license identifier associated with a unique one of the at least one license.

32. The method of claim 31, wherein obtaining the at least one license identifier further comprises generating at least one issuer code, wherein the issuer code is issued by a central registration service and is assigned to a unique one of the at least one licensing entity, which issues the at least one license.

33. The method of claim 31, wherein obtaining the at least one license identifier further comprises obtaining at least one license reference, which is allocated uniquely by a unique one of the at least one licensing entity that has been assigned an issuer code to identify the at least one license and accompanying metadata associated with the at least one license.

34. The method of claim 31, wherein obtaining the at least one license identifier further comprises calculating a check character.

35. The method of claim 31, wherein generating the at least one license identifier further comprises obtaining a society auxiliary extension, which is allocated uniquely by one of the at least one licensing entity that has been assigned an issuer code to distinguish between different versions of the at least one license.

36. The method of claim 31, wherein obtaining the at least one license identifier further comprises obtaining a license identifier scheme, which uniquely identifies an identification scheme for the at least one license.

37. The method of claim 31, wherein there is a one-to-many relationship between the at least one license and the at least one release such that the at least one license identified by the at least one license identifier is associated with a plurality of releases.

38. The method of claim 31, wherein there is a one-to-many relationship between the at least one license and the at least one release such that the at least one release is associated with a plurality of licenses identified by the at least one license identifier.

39. A method of administering a release identifier, comprising:
issuing at least one issuer code, wherein the at least one issuer code is issued by a central registration service and is assigned to a unique one of at least one issuing entity; and
issuing at least one release having a release identifier comprising the at least one issuer code, wherein the at least one release is issued by the unique one of the at least one issuing entity.

40. A method of administering a license identifier, comprising:
issuing at least one issuer code, wherein the at least one issuer code is issued by a central registration service and is assigned to a unique one of at least one licensing entity; and
issuing at least one license having a license identifier comprising the at least one issuer code, wherein the at least one license is issued by the unique one of the at least one licensing entity.

41. A method of exchanging information regarding at least one release, comprising:
converting, by a first entity, a release identifier and metadata associated with the at least one release from a first proprietary format associated with the first entity into a standard format, wherein the standard format comprises a standard metadata schema;
mapping, by the first entity, the release identifier and the metadata associated with the at least one release into appropriate fields within the standard metadata schema;
transmitting the release identifier and metadata from the first entity to a second entity; and
converting, by the second entity, the release identifier and the metadata associated with the at least one release from the standard format into a second proprietary format associated with the second entity, wherein the release identifier and the metadata identify and describe the at least one release.

42. A method of exchanging information regarding at least one license, comprising:
converting, by a first entity, a license identifier and metadata associated with the at least one license from a first proprietary format associated with the first entity into a standard format, wherein the standard format comprises a standard metadata schema;
mapping, by the first entity, the license identifier and the metadata associated with the at least one license into appropriate fields within the standard metadata schema;
transmitting the license identifier and metadata from the first entity to a second entity; and
converting, by the second entity, the license identifier and the metadata associated with the at least one license from the standard format into a second proprietary format associated with the second entity, wherein the license identifier and the metadata identify and describe the at least one license.
